(19) United States
(12) Patent Application Publication
(10) Pub. No.: US 2018/0158152 A1
(43) Pub. Date: Jun. 7, 2018

(54) Methods and Software for Calculating Optimal Power Flow in an Electrical Power Grid and Utilizations of Same

(71) Applicant: Carnegie Mellon University, Pittsburgh, PA (US)

(72) Inventors: Marko Jereminov, Pittsburgh, PA (US); Lawrence Pileggi, Pittsburgh, PA (US); Amritanshu Pandey, Pittsburgh, PA (US)

(21) Appl. No.: 15/658,335

(22) Filed: Jul. 24, 2017

Related U.S. Application Data
(60) Provisional application No. 62/497,854, filed on Dec. 5, 2016.

(51) Int. Cl. G06Q 50/06; H02J 3/16; G05B 13/04

(52) U.S. Cl. CPC G06Q 50/06; H02J 2003/007; G05B 13/048; H02J 3/16

(57) ABSTRACT

Methods of calculating optimal power flows (OPFs) in power transmission and distribution networks using equivalent-circuit formulations that allow the solutions to converge to corresponding global minima. In some aspects, network (circuit) elements are modeled using split circuits composed of real and imaginary parts. A variety of nonlinear OPF problem formulations are disclosed, including direct-solution formulations and iterative-solution formulations based on converting real and reactive power constraints to equivalent conductance/susceptance constraint. Also disclosed are a variety of techniques for solving the disclosed OPF problems, including new admittance-stepping homotopy techniques, among others. Software embodying disclosed methods is also described, as are example implementation scenarios.

### RELATED APPLICATION DATA

This application claims the benefit of priority of U.S. Provisional Patent Application Ser. No. 62/497,854, filed on Dec. 5, 2016, and titled “Optimal power flow using equivalent circuit formulation,” which is incorporated by reference herein in its entirety.

### FIELD OF THE INVENTION

The present invention generally relates to the field of electrical power generation, transmission and distribution. In particular, the present invention is directed to method and software for calculating optimal power flow in an electrical power grid and utilizations of same.

### BACKGROUND

Power flow method based on iteratively solving the nonlinear power mismatch equations was first conceived of five decades ago, and it remains the standard for simulating transmission-level power grids. As indicated by its name, the objective of power flow is to simulate the net transfer of power within a power system, whereby each bus (a “node” in the grid) is characterized by four quantities:

Real power (P);

Reactive power (Q);

Voltage magnitude (V); and

Voltage phase (θ).

Furthermore, these four quantities define the three types of buses that are specified as:
PV bus (generator), where real power and voltage magnitude are known, and reactive power and voltage phase are state variables;
PQ bus (load), where the real and reactive powers are known, and voltage magnitude and phase are the state variables; and
Vθbus (reference bus), where the voltage magnitude and angle are known, while the real and reactive powers are unknown variables.

Not long after the first power flow formulation was postulated, the optimal power flow (OPF) problem was introduced by Carpentier in J. Carpentier, “Contribution to the economic dispatch problem”, Bulletin de la Societe Francaise des Electriciens, 8 (1962), pp. 431-447. The motivation of OPF was to find a steady-state operating point of a power system that minimizes the cost of generated real power while satisfying the operating and stability constraints and load demand. It was soon realized, however, that the OPF problem formulated using the aforementioned power flow equations and variables represented an extremely nonconvex programming problem with many local optimal solutions, and it is presently recognized as a very difficult problem to solve. Most importantly, due to highly nonlinear, non-convex constraints, the optimal power flow problem algorithms have changed little over the past decades. Today, half a century after it was postulated, the fast and robust solution technique to solve the full AC optimal power flow problem still doesn't exist. Finding a formulation that can robustly solve the OPF problem has enormous implications. For example, in M. B Cain, R. P. O'Neill, A. Castillo, “History of Optimal Power Flow and Formulations”, Optimal Power Flow Paper 1, FERC, December 2012, the authors state: “if we make a rough estimate that today's solvers are on average off by 10%, and world energy costs are $400 billion, closing the gap by 10% is a huge financial impact.”

### SUMMARY OF THE DISCLOSURE

In one implementation, the present disclosure is directed to a method that includes formulating, for an electrical power system, current and voltage conservation equations from which power flows, currents, and voltages can be derived, wherein the current and voltage conservation equations correspond to an equivalent circuit representation of the electrical power system that includes: a real sub-circuit including all real-valued voltages and currents; and an imaginary sub-circuit containing all imaginary-valued voltages and currents, wherein: the real sub-circuit and imaginary sub-circuit are coupled via controlled voltage and current sources; and the generators are modeled by combinations of complex admittances and current or voltage sources of unknown value that represent their power delivery capabilities; and running an optimization program for the power flow conservation equations so as to produce a minimum cost for operating the electrical power system based on the solution of control parameter values for the generator models in the system.

In another implementation, the present disclosure is directed to a machine-readable storage medium containing machine-executable instructions configured to cause one or more processors to perform operations, which includes formulating, for an electrical power system, current and voltage conservation equations from which power flows, currents, and voltages can be derived, wherein the current and voltage conservation equations correspond to an equivalent circuit representation of the electrical power system that includes: a real sub-circuit including all real-valued voltages and currents; and an imaginary sub-circuit containing all imaginary-valued voltages and currents, wherein: the real sub-circuit and imaginary sub-circuit are coupled via controlled voltage and current sources; and the generators are modeled by combinations of complex admittances and current or voltage sources of unknown value that represent their power delivery capabilities; and running an optimization program for the power flow conservation equations so as to produce a minimum cost for operating the electrical power system based on the solution of control parameter values for the generator models in the system.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a diagram illustrating a split-circuit equivalent for a PV bus;

FIG. 2 is a diagram illustrating a voltage magnitude constrained circuit;

FIG. 3 is a diagram illustrating equivalent circuitry of a susceptance-current-conductance (BIG) load model;

FIG. 4 is a diagram illustrating complex power supplied by an admittance;

FIG. 5 is a diagram illustrating a reformulated equivalent circuit of a PV generator;

FIG. 6 is a diagram illustrating a reformulated generator split-circuit;

FIG. 7 is a diagram illustrating a nonlinear equivalent control circuit of a voltage magnitude;

FIG. 8 is a diagram illustrating a simplified transmission line segment;

FIG. 9 is a diagram illustrating a variable shunt equivalent circuit;

FIG. 10 is a diagram illustrating a controllable series element equivalent circuit;

FIG. 11 is a diagram illustrating a transformer equivalent split-circuit;

FIG. 12 is a diagram illustrating a modified equivalent circuit of a PQ load;

FIG. 13 is a diagram illustrating an admittance load model and a BIG load model;

FIG. 14 is diagram illustrating a ∇_{λ} [symbol] split-circuit of a PV generator;

FIG. 15 is a diagram illustrating a ∇_{λ} [symbol] split-circuit of a PV generator;

FIG. 16 is diagram illustrating a ∇_{λ} [symbol] split-circuit of a PQ load model;

FIG. 17 is a diagram illustrating a ∇_{λ} [symbol] split-circuit of a PQ load model;

FIG. 18 is a diagram illustrating a ∇_{λ} [symbol] split-circuit of a BIG load;

FIG. 19 is diagram illustrating a ∇_{λ} [symbol] split-circuit of a voltage magnitude constraint;

FIG. 20 is diagram illustrating a ∇_{λ} [symbol] split-circuit of a voltage magnitude constraint;

FIG. 21 is diagram illustrating a ∇_{λ} [symbol] split-circuit of a variable shunt element;

FIG. 22 is diagram illustrating a ∇_{λ} [symbol] split-circuit of a variable shunt element;

FIG. 23 is diagram illustrating a ∇_{λ} [symbol] split-circuit of a slack bus generator;

FIG. 24 is diagram illustrating a ∇_{λ} [symbol] split-circuit of a slack bus generator;

FIG. 25 is diagram illustrating a ∇_{λ} [symbol] split-circuit of a transmission line;

FIG. 26 is diagram illustrating a ∇_{λ} [symbol] split-circuit of a transmission line;

FIG. 27 is diagram illustrating a ∇_{λ} [symbol] split-circuit of a slack bus generator;

FIG. 28 is a diagram illustrating an equivalent circuit representation of admittance-stepping (“A-stepping” homotopy;

FIG. 29 is a diagram illustrating inputs and outputs of an example optimal power flow (OPF) method of the present disclosure;

FIG. 30 is a flow diagram illustrating an example method of solving an OPF directly or interactively in accordance with aspects of the present invention;

FIG. 31A is a flow diagram illustrating an example method of solving a Full-OPF in accordance with aspects of the present invention;

FIG. 31B is a flow diagram illustrating an example method of solving a simplified OPF in accordance with aspects of the present invention;

FIG. 32 is a flow diagram illustrating an example method of solving an AC-OPF in accordance with aspects of the present invention;

FIG. 33 is a high-level diagram illustrating implementation of an OPF solver in a power grid network;

FIG. 34 is a high-level schematic diagram illustrating a known simulated 3-bus test case for solving using an OPF solver made in accordance with aspects of the present invention;

FIG. 35 is a high-level schematic diagram illustrating a known simulated 5-bus test case for solving using an OPF solver made in accordance with aspects of the present invention;

FIG. 36 is a high-level schematic diagram illustrating a known simulated 9-bus test case for solving using an OPF solver made in accordance with aspects of the present invention;

FIG. 37 is a high-level schematic diagram illustrating a known simulated 39-bus test case for solving using an OPF solver made in accordance with aspects of the present invention; and

FIG. 38 is a block diagram of a computing system that can contain and/or be used to implement any one or more of the OPF methodologies disclosed herein.

### DETAILED DESCRIPTION

### I. Introduction

### I. A Traditional Optimal Power Flow (OPF) Algorithm

Contrary to the traditional power flow formulation, wherein the real power generated by a PV (generator) bus and voltage magnitude are known, the OPF formulation treats these two quantities as unknown variables. In addition, some OPF formulations don't even keep the slack bus voltage magnitude constant, but use it as a control variable as well. It is important to note that there have been many proposed objective functions that are to be optimized for OPF, such as minimizing generation cost, maximizing market surplus, minimizing generation, etc.; however, the most important objective function is the real power generation cost:

$${ℱ}_{cost} = {\sum }_{i = 1}^{N} [ {a}_{i} + {b}_{i} {P}_{G , i} + {c}_{i} {P}_{G , i}^{2} ] \qquad ( 1 )$$

wherein N is the number of generators (PV buses and a slack bus) in the power system, P_{G,i} is the generated real power of i^{th} generator and aᵢ, bᵢ and cᵢ are the generation cost coefficients.

Since the objective function has to be minimized while satisfying the power flow in the grid, the conversion-like equations in terms of real and reactive power flows are added as equality constraints:

$$\begin{matrix}{P}_{k} = {\sum }_{m ∈ {Ω}_{k}} {P}_{km} ( {V}_{k} , {V}_{m} , {θ}_{k} , {θ}_{m} ) & ( 2 ) \\ {Q}_{k} = {\sum }_{m ∈ {Ω}_{k}} {Q}_{km} ( {V}_{k} , {V}_{m} , {θ}_{k} , {θ}_{m} ) & ( 3 )\end{matrix}$$

wherein kϵ[1, N], N is the total number of buses in the system, Ωₖ is the set of buses adjacent to bus k, Pₖₘ is the active power flow from bus k to bus m, and Qₖₘ is the reactive power flow from bus k to bus m. It should be noted that the power balance equations from Equations (2) and (3) used in traditional power flow represent highly nonlinear and non-convex constraints, thereby making the optimization problem NP hard to solve for a global minimum.

In addition to the constraints given by Equations (2) and (3), there are the operating and stability inequality constraints that need to be satisfied for each bus and a transmission line in the power system:

### Generator Bus Inequality Constraints:

Each generator in the system has an upper and lower bound constraints on generated real power Pₖ and reactive power Qₖ given as:

Pₘᵢₙ≤Pₖ≤Pₘₐₓ (4)

Qₘᵢₙ≤Qₖ≤Qₘₐₓ (5)

### Transmission Line Inequality Constraints:

There are two important operating limits for the transmission line power flow incorporated in the traditional OPF. The first one represents a thermal transmission limit based on temperature sensitivity of the conductor in a line, and is defined as a maximum apparent power Sₗᵢₙₑ that can be allowed to flow in the line:

Sₗᵢₙₑ≤Sₘₐₓ (6)

The second important line constraint is a stability constraint that bounds the voltage angle difference between sending and receiving sides of a transmission line and is given as:

−θₘₐₓ≤θₖ−θₘ≤θₘₐₓ (7)

Lastly, in order to ensure that the power system operates around the stable nominal operating point, the voltage magnitude at each bus is limited by the upper and lower bounds as:

Vₘᵢₙ≤|Vₖ|≤Vₘₐₓ (8)

As can be seen from the constraints incorporated into the traditional OPF formulation, i.e., Equations and Constraints (2)-(8) above, the nonconvex powerflow equality constraints represent the biggest impediment of this formulation. More importantly, even for extremely small test cases (˜3 to 5 buses), there are dozens of local optimal solutions that make it difficult to robustly solve for the global optimal solution. It is noted that there are other formulations that can be found in the literature that reduce the nonlinearity and non-convexity of the equality power flow constraints by using rectangular coordinates (current and voltage) for optimal power flow; however, all of these proposed formulations are based on the traditional problem assumptions and models that introduce other non-convexities in the inequality constraints and keep the OPF problem as nonconvex. There have been a few recent attempts to derive the global OPF formulations using convex relaxation algorithms, i.e. application of Semi-Definite programming (SDP); however, all of them suffered from various drawbacks, hence were unable to guarantee convergence to the global optimum solution in general.

### I. B Equivalent Split-Circuit Formulation for Solving the Power Flow

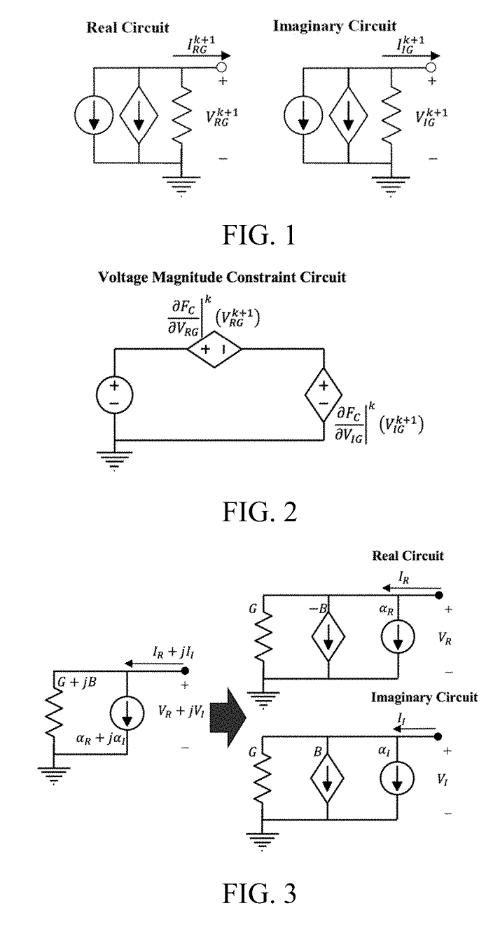

An equivalent circuit approach to generalized modeling of a power system's steady-state response, i.e. power flow, is described in U.S. patent application Ser. No. 15/456,341 titled “SYSTEMS, METHODS, AND SOFTWARE FOR PLANNING, SIMULATING, AND OPERATING ELECTRICAL POWER SYSTEMS” in the name of Pileggi et al. (“the '341 application”), which is incorporated herein by reference for its teachings of the aforementioned equivalent circuit approach. In that application it is shown that each of the power system components could be translated to an equivalent circuit model based on underlying relations between current and voltage state variables without loss of generality. Moreover, in order to ensure the analyticity of nonlinear complex governing circuit equations, they are split into real and imaginary parts. As illustrated in FIG. 1, splitting of complex equations corresponds to splitting of the complex equivalent circuit into two sub-circuits, i.e. a real and an imaginary, coupled by the controlled sources, and hence permits the application of the Newton Raphson method to solve the circuit equations.

For instance, the equivalent split-circuit formulation provides a choice to model the PV (generator) bus as either a complex voltage source (in terms of complex current) or a complex current source (in terms of complex voltage). It has been shown that representing the PV bus as a complex current source offers superior convergence for Newton-Raphson (NR) iterations. To enable the application of NR, the complex current source is split into real and imaginary current sources (I_{RG} and I_{IG}, respectively).

$$\begin{matrix}{I}_{RG} = \frac{- {P}_{G}}{{\vert {V}_{G} \vert}^{2}} {V}_{RG} + \frac{{Q}_{G}}{{\vert {V}_{G} \vert}^{2}} {V}_{IG} & ( 9 ) \\ {I}_{IG} = \frac{- {P}_{G}}{{\vert {V}_{G} \vert}^{2}} {V}_{IG} - \frac{{Q}_{G}}{{\vert {V}_{G} \vert}^{2}} {V}_{RG} & ( 10 )\end{matrix}$$

wherein P_{G} and |V_{G}| predefined real power generated and voltage magnitude that characterize the PV bus, V_{RG} and V_{IG} are the real and imaginary voltage state variables. Moreover, an additional constraint equation for the voltage magnitude is needed for the PV model to ensure that the voltage is equal to its set point but also to compensate for the additional unknown variable for the reactive power Q_{G}, i.e.:

F_{c}=V_{RG}²+V_{IG}²−|V_{G}|²≡0 (11)

To obtain the linearized equivalent circuit of the nonlinear governing generator equations, i.e., Equations (9)-(11), the equations are expanded via a first order Taylor expansion around (k+1)^{th} iteration as:

$$\begin{matrix}{I}_{RG}^{k + 1} = \frac{\partial {I}_{RG}}{\partial {Q}_{G}} {\vert}^{k} ( {Q}_{G}^{k + 1} ) + \frac{\partial {I}_{RG}}{\partial {V}_{RG}} {\vert}^{k} ( {V}_{RG}^{k + 1} ) + \frac{\partial {I}_{RG}}{\partial {V}_{IG}} {\vert}^{k} ( {V}_{IG}^{k + 1} ) + {I}_{RG}^{k} - \frac{\partial {I}_{RG}}{\partial {Q}_{G}} {\vert}^{k} ( {Q}_{G}^{k} ) - \frac{\partial {I}_{RG}}{\partial {V}_{RG}} {\vert}^{k} ( {V}_{RG}^{k} ) - \frac{\partial {I}_{RG}}{\partial {V}_{IG}} {\vert}^{k} ( {V}_{IG}^{k} ) & ( 12 ) \\ {I}_{IG}^{k + 1} = \frac{\partial {I}_{IG}}{\partial {Q}_{G}} {\vert}^{k} ( {Q}_{G}^{k + 1} ) + \frac{\partial {I}_{IG}}{\partial {V}_{RG}} {\vert}^{k} ( {V}_{RG}^{k + 1} ) + \frac{\partial {I}_{RG}}{\partial {V}_{IG}} {\vert}^{k} ( {V}_{IG}^{k + 1} ) + {I}_{RG}^{k} - \frac{\partial {I}_{IG}}{\partial {Q}_{G}} {\vert}^{k} ( {Q}_{G}^{k} ) - \frac{\partial {I}_{IG}}{\partial {V}_{RG}} {\vert}^{k} ( {V}_{RG}^{k} ) - \frac{\partial {I}_{IG}}{\partial {V}_{IG}} {\vert}^{k} ( {V}_{IG}^{k} ) & ( 13 ) \\ \frac{\partial {F}_{C}}{\partial {V}_{RG}} {\vert}^{k} ( {V}_{RG}^{k + 1} ) + \frac{\partial {F}_{C}}{\partial {V}_{IG}} {\vert}^{k} ( {V}_{IG}^{k + 1} ) + {F}_{C}^{k} - \frac{\partial {F}_{C}}{\partial {V}_{RG}} {\vert}^{k} ( {V}_{RG}^{k} ) - \frac{\partial {F}_{C}}{\partial {V}_{IG}} {\vert}^{k} ( {V}_{IG}^{k} ) = 0 & ( 14 )\end{matrix}$$

The first terms of linearized real and imaginary currents, i.e., Equations (12) and (13) represent current sources that are the function of the reactive power Q_{G}. Further, the terms that are proportional to the voltage across them, can be represented by the conductance defined by the values of respective partial derivatives, while the terms that are proportional to the voltage across the other circuit are represented by voltage controlled current sources. In addition, the remaining terms are all dependent on known values from the previous iteration, so they can be lumped together and represented as an independent current source.

Equation (14) can be translated to the equivalent circuit as shown in FIG. 2, wherein the independent voltage source represents the last three terms already known from the previous iteration, while the two voltage controlled voltage source represent first two terms dependent on the real and imaginary generator voltages from current iteration.

### I. C BIG Load Modeling

An equivalent split-circuit generalized modeling approach was demonstrated as a robust method for solving the power flow problem in the '341 application noted above. Circuit simulation techniques can be directly applied to the power system simulations, hence bringing the capabilities of simulating large scale systems as well as guaranteeing the convergence to the desired physical solution of the grid. Moreover, the approach further allows for the application of circuit reduction techniques and moment matching theory to create more accurate load modeling. A B-I-G (susceptance-current-conductance, also “BIG”) load model is given in FIG. 3 more accurately captures actual load behavior as compared to the traditional load models. The model can be generated from real-time measurement data. Importantly, since the BIG load model is linear in equivalent current/voltage split circuit formulation, it and other linear models like it result in linear equality constraints for the load bus of power-flow analysis.

### I. D Aspects of the Invention

In some aspects, the present invention includes using an equivalent split-circuit approach to redefine the traditional real power cost minimization optimal power flow in terms of a current/voltage formulation. A key concept is the reformulation of the generator (PV) bus model that defines the real and reactive powers using the known voltage magnitude and conductance/susceptance models as unknown variables. The traditional operational and stability limits are translated to the current/voltage formulation using the new conductance and susceptance control variables, without loss of generality. It can be shown that the proposed formulation results in the convex cost function with inequality constraints and that the nonlinearities appear in terms of bilinear equality constraints. Thus, McCormick convex envelope relaxation can be efficiently applied to handle nonlinearities of the formulation and used in the algorithm that can further obtain the global optimal solution. Importantly, aspects of the present invention are not constrained by a particular real power cost function, and they provide a general algorithm capable of incorporating any existing power grid optimization problem and can be used for developing new ones, such as minimizing both real and reactive powers concurrently.

In order to improve the efficiency of the introduced invention and decrease the overall nonlinearities due to the bilinear constraints from the definition of real and reactive generation powers, an iterative OPF approach is postulated, whereby the real and reactive power constraints are converted to equivalent conductance/susceptance constraints and are fitted to match the P and Q definitions at a specific voltage. Since the voltage can change slightly during an OPF solve, an iterative update of these constraints may be applied after each OPF solve to ensure consistency between the models used and the voltage values. This iteration of OPF can be applied until convergence; however, in practice it is found that one iteration is generally sufficient. Moreover, as a substitution to the traditional (simpler and less accurate) PQ load models, the linear and more accurate BIG load models based on measurement data is suggested, which further yields the load constraints as linear, contrary to the bilinear nonlinearities introduced by the traditional PQ loads.

The introduced invention includes a method that can be used for the real-time simulation of the optimal power flow, as well as for the efficient operation and planning, wherein the network models can be updated based on measurement data form the field. Most importantly, it is applicable for the robust and accurate security constrained optimal power flow (SCOPF) and market dispatch. As a proof of concept, several test benchmark cases that are known in literature to have multi optima solutions for the traditional nonconvex OPF formulation are shown to converge to a global minimum. Below is a detailed description of the OPF models, formulation, methods and implementations, followed by test case examples.

### II. General Description

### II. A GB Generator (PV) Bus Equivalent Split-Circuit Model

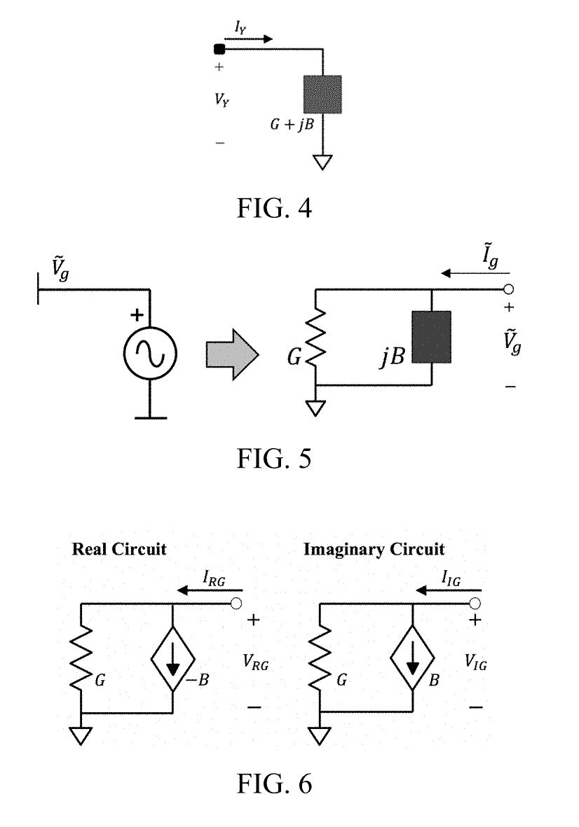

In order to completely understand the generator model from the equivalent circuit perspective, given by governing Equations (9) and (10), an admittance is considered to be connected from a node k to ground, as shown in FIG. 4, for Y=G+jB.

The complex power consumed by the admittance, Y can be expressed in terms of complex voltage across the admittance and its complex current as given by Equation (15).

P_{Y}+jQ_{Y}=V_{Y}I_{Y}* (15)

By replacing the complex conjugate current with an Ohm's law equivalent function in terms of voltage and admittance given as:

I_{Y}=V_{Y}(G+jB) (16)

Equation (15) can be rewritten as:

P_{Y}+jQ_{Y}=|V_{Y}|²G−j|V_{Y}|²B (17)

It is noted from Equation (16) that the real and reactive power consumed by the admittance can be written as a function of voltage magnitude |V_{G}| and the conductance and susceptance, G and B, respectively. Furthermore, by expressing the conductance and susceptance from Equation (17) as functions of voltage magnitude and real and reactive powers respectively, Equation (16) can be reformulated as:

$${I}_{Y} = {V}_{Y} ( \frac{{P}_{Y}}{{\vert {V}_{Y} \vert}^{2}} - j \frac{{Q}_{Y}}{{\vert {V}_{Y} \vert}^{2}} ) \qquad ( 18 )$$

Then, by splitting the complex current function from Equation (18), the split-circuit governing equations can be given as:

$$\begin{matrix}{I}_{RY} = \frac{{P}_{Y}}{{\vert {V}_{Y} \vert}^{2}} {V}_{RY} + \frac{{Q}_{Y}}{{\vert {V}_{Y} \vert}^{2}} {V}_{IY} & ( 19 ) \\ {I}_{IY} = \frac{{P}_{Y}}{{\vert {V}_{Y} \vert}^{2}} {V}_{IY} + \frac{- {Q}_{Y}}{{\vert {V}_{Y} \vert}^{2}} {V}_{RY} & ( 20 )\end{matrix}$$

As can be seen by comparing Equations (19) and (20) with the governing equations of a PV generator model (Equations (9) and (10)), the current flowing into the admittance illustrated in FIG. 4 is equivalent to the negative current flowing into (positive current flowing out of) the PV generator mode. It follows that a PV bus model can be represented by an admittance that supplies power to the circuit. For example, a negative real admittance G would supply real power to the system, in contrast to a positive real admittance G that would consume it (as in a load). This is consistent with the treatment of negative real admittance from circuit theory in general.

To model a PV bus, the generator bus split-circuit model is reformulated in terms of conductance and a susceptance that supply the complex power to the circuit:

I_{G}=V_{G}(G+jB) (21)

The complete complex equivalent of a generator bus is presented in FIG. 5. It is noted that in addition to the new generator equivalent circuit, a voltage constraint (for the known magnitude in terms of the real and imaginary voltages) still needs to be incorporated, and its equivalent circuit remains the same as presented in FIG. 2.

The complete equivalent split circuit, presented in FIG. 6, can be further derived by splitting the real and imaginary parts of the new PV generator governing Equation (21):

I_{RG}=GV_{RG}−BV_{IG} (22)

I_{G}=GV_{IG}+BV_{RG} (23)

### II. B GB Generator (PV) Bus Equivalent Split-Circuit Model

The real power generated by the PV bus can be expressed as a function of generator bus voltage magnitude and conductance that supplies power, hence for each k^{th} real power state variable introduced by the cost function from Equation (1), the following equality constraints are added:

P_{Gk}=−Gₖ|V_{Gk}|² (24)

It is important to note that a reformulated real power constraint of Equation (24) is a trilinear function. Moreover, it is shown in the following section that the trilinear nonlinearities introduced by the power state variables can be completely removed from the formulation, hence, yielding the bilinear nonlinearities that allow the efficient application of McCormick convex envelope relaxation. If an iterative OPF is to be applied or voltage magnitude for a particular generator needs to be fixed to a constant value, there is no need for adding the extra constraints for that real power state variable, and the cost function for the respective real power generation can be reformulated as a quadratic function of conductance, Gᵢ, as shown in Equation (25):

$${ℱ}_{PV}^{G} = {\sum }_{i = 1}^{N} [ {a}_{i , P} + {\overline{b}}_{i , P} {G}_{i} + {\overline{c}}_{i , P} {G}_{i}^{2} ] \qquad ( 25 )$$

wherein b̅_{i,P}=bᵢ|V_{Gk}|² and c̅_{i,P}=cᵢ|V_{Gk}|⁴, for fixed voltage magnitude, i.e. |V_{Gk}|

Following a similar approach as for the PV bus, a reformulated slack bus real power and its cost function can be derived. Since the voltage angle of a slack bus is set to zero as a reference bus, its real power generated P_{SB} can expressed as a bilinear function in terms of the slack bus voltage and real current:

P_{SB}=−V_{SB}I_{R} (26)

wherein V_{SB} is a slack bus voltage equal to the voltage magnitude of a slack bus; i.e. imaginary part is zero, and I_{R} is the real current of a slack bus.

It should be noted that the bilinear equality constraint from Equations (26) will be added as an additional constraint for the real slack bus power state variable introduced by its cost function. Importantly, the bilinear functions may be efficiently handled by the McCormick convex envelope relaxation. However, if an iterative OPF is to be applied or the slack bus magnitude is desired to be constant, the additional equality constraint from Equation (26) will not be added, but the cost function will be reformulated as a quadratic function in terms of real slack bus current given below:

[symbol]

_{SB}=a_{sb}+b̅_{sb}I_{R}+c̅_{sb}I_{R}² (27)

wherein b̅_{sb}=bᵢV_{SB} and c̅_{sb}=cᵢV_{SB}², for fixed voltage magnitude, i.e. V_{SB}

### II. C Reactive Power Generation Cost Function

It was previously shown that the generator's reactive power at a PV bus can be also redefined as a function of generator's voltage and susceptance, i.e., B. Thus, the proffered formulation can incorporate the reactive power cost minimization without any loss of generality.

For a given reactive power cost function of a PV generator bus:

$${ℱ}_{cost}^{Q} = {\sum }_{i = 1}^{N} [ {a}_{i , Q} + {b}_{i , Q} {Q}_{G , i} + {c}_{i , Q} {Q}_{G , i}^{2} ] \qquad ( 28 )$$

a trilinear equality constraint that defines a reactive power for i^{th} PV bus in terms of newly introduced state variables will be added as:

Q_{G,i}=Bᵢ|V_{Gi}|² (29)

As in the case for the real slack bus power, defined as a function of the voltage and real current, i.e., Equation (26), the reactive slack bus power can be redefined as a bilinear function in terms of the slack bus voltage and imaginary slack bus current:

Q_{SB}=V_{SB}I_{I} (30)

wherein V_{SB} is a slack bus voltage equal to the voltage magnitude of a slack bus; i.e. imaginary part is zero, and I_{I} is the imaginary current of a slack bus.

It is noted that if an iterative OPF is to be applied or the slack bus voltage magnitude is desired to stay fixed, additional constraints given in Equations (29) and (30) will not be added to the formulation, and the reactive cost functions can be reformulated as quadratic functions of susceptance and imaginary current respectively for the PV and slack bus:

$$\begin{matrix}{ℱ}_{PV}^{Q} = {\sum }_{i = 1}^{N} [ {a}_{i , Q} + {\overline{b}}_{i , Q} {B}_{i} + {\overline{c}}_{i , Q} {B}_{i}^{2} ] & ( 31 ) \\ {ℱ}_{SB}^{Q} = {a}_{sb , Q} - {\overline{b}}_{sb , Q} {I}_{I} + {\overline{c}}_{sb , Q} {I}_{I}^{2} & ( 32 )\end{matrix}$$

wherein b̅_{i,Q}=bᵢ|V_{G}|², c̅_{i,Q}=cᵢ|V^{Gi}|⁴, b̅_{sb,Q}=bᵢV_{SB}, and c̅_{sb,Q}=cᵢV_{SB}² for fixed voltage magnitudes, i.e., V_{SB} and |V_{Gi}|.

The generalized cost function that includes minimization of both real and reactive powers generated can be further defined as:

$${ℱ}_{cost}^{PQ} = {\sum }_{i = 1}^{N} [ {a}_{i} + {b}_{i} {P}_{G , i} + {c}_{i} {P}_{G , i}^{2} + {a}_{i , Q} + {b}_{i , Q} {Q}_{G , i} + {c}_{i , Q} {Q}_{G , i}^{2} ] \qquad ( 33 )$$

wherein each of the introduced power state variables, i.e. P_{G,i} and Q_{G,i}, require the additional bilinear and trilinear constraints as defined by (24), (26), (29), and (30). Furthermore, in the case of iterative OPF, wherein the voltage magnitude is set to be constant at each iteration, the generalized cost function can be reformulated as a quadratic function in terms of conductance, susceptance, real and imaginary currents for the PV and Slack bus respectively.

$${ℱ}_{cost}^{GB} = {a}_{sb} + {b}_{sb} {I}_{R} + {c}_{sb} {I}_{R}^{2} + {a}_{sb , Q} - {b}_{sb , Q} {I}_{I} + {c}_{sb , Q} {I}_{I}^{2} + {\sum }_{i = 1}^{N} [ {a}_{i} + {b}_{i} {G}_{i} + {c}_{i} {G}_{i}^{2} + {a}_{i , Q} + {b}_{i , Q} {B}_{i} + {c}_{i , Q} {B}_{i}^{2} ] \qquad ( 34 )$$

II. D Removing the Trilinear Nonlinearities from the Formulation

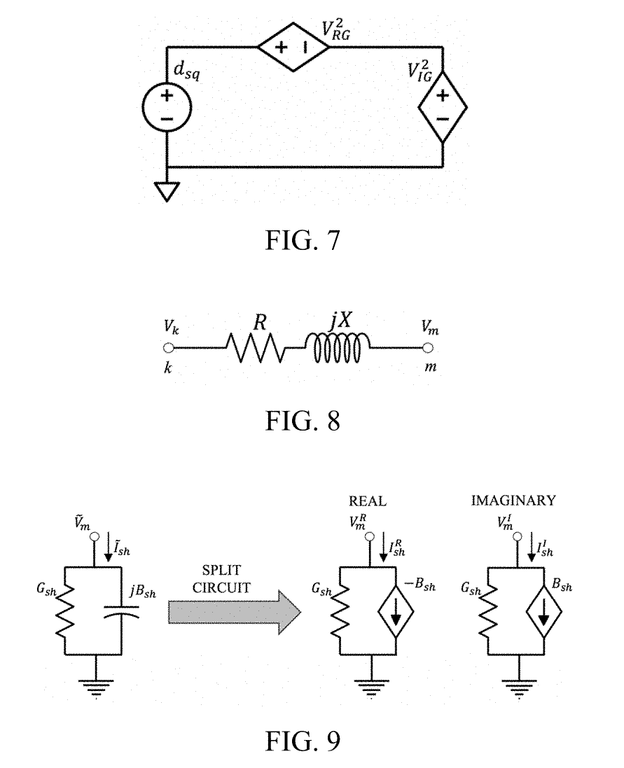

The voltage magnitude at each bus in the system is a control variable in the AC-OPF problem. Moreover, it can be shown that the it only appears as the squared term throughout the proposed formulation. Thus, in order to reduce the nonlinearities of the formulation introduced by the definition of real and reactive powers, Equations (24) and (29), the variable d_{sq} is defined that substitutes the “|V_{Gi}|²” term, namely, d_{sq}=|V_{Gi}|². The voltage magnitude equality constraint that further corresponds to an equivalent circuit shown in FIG. 7 is then written as:

d_{sq}=V_{RG}²+V_{IG}² (35)

It is noted that the same equality constraint will be used to set operating limits at every bus in the power system. The real and reactive power constraints from Equations (24) and (29) are further reformulated as the bilinear functions in terms of conductance, susceptance and d_{sq} variables as:

P_{G}=−Gd_{sq} (36)

Q_{G}=Bd_{sq} (37)

### II. E Redefining OPF Inequality Constraints

One of the biggest drawbacks of the existing current/voltage formulated OPF problems is the non-convexities introduced while representing the traditional OPF boundary constraints; i.e. real and reactive power generated, etc., represented purely in terms of currents and voltages. Since it has been previously shown that generated complex power can be defined in terms of voltage magnitude and the admittance, the traditional OPF constraints from Equations (4)-(8) can be reformulated.

### II. E. i Generator Bus Real and Reactive Powers Bounds:

Since the real and reactive power state variables are already introduced in the cost function and the bilinear equality constraints from Equations (39) and (40), the same inequality constraints as the ones given in Constraints (4) and (5) can be used to set the bounds on generated powers of a PV bus. However, it is important to note that if an iterative OPF algorithm is to be used or the voltage at the generator PV bus is desired to stay constant, bounding the real and reactive power becomes equivalent to setting the lower and upper bounds for conductance and susceptance at a fixed voltage magnitude, i.e. |V_{G}|:

$$\begin{matrix}\frac{{P}_{min}}{{\vert {V}_{Gk} \vert}^{2}} \leq {G}_{k} \leq \frac{{P}_{max}}{{\vert {V}_{Gk} \vert}^{2}} & ( 38 ) \\ \frac{{Q}_{min}}{{\vert {V}_{Gk} \vert}^{2}} \leq {B}_{k} \leq \frac{{Q}_{max}}{{\vert {V}_{Gk} \vert}^{2}} & ( 39 )\end{matrix}$$

### II. E. ii Slack Generator Bus Real and Reactive Power Bounds:

A slack bus real and reactive powers will be constrained by setting the limits as given by Constraints (4) and (5). Importantly, similarly to the PV bus wherein the real and reactive powers are constrained using the conductance and susceptance in the case of iterative OPF or known slack bus voltage magnitude, the real and imaginary slack bus currents can be used to constraint the real and reactive power generated. The lower and upper bounds for the real and imaginary generator's currents will be derived at the fixed (nominal) voltage |Vₖ|=V_{SB} as:

$$\begin{matrix}\frac{{P}_{min}}{{V}_{SB}} \leq {I}_{Rk} \leq \frac{{P}_{max}}{{V}_{SB}} & ( 40 ) \\ \frac{{Q}_{max}}{{V}_{SB}} \leq {I}_{Ik} \leq \frac{{Q}_{min}}{{V}_{SB}} & ( 41 )\end{matrix}$$

As in the traditional OPF, where it can be ensured that the power system operates around the stable nominal operating point, the voltage magnitude at each bus in our formulation is limited by the upper and lower bounds as:

Vₘᵢₙ≤|Vₖ|≤Vₘₐₓ (42)

### II. E. iii PV Bus Voltage Angle Constraint:

Some of the existing OPF formulation also bound the voltage angle at each PV bus, i.e., as an inequality constraint given in Constraint (43) as follows:

$${θ}_{min} \leq {tan}^{- 1} ( \frac{{V}_{I}^{k}}{{V}_{R}^{k}} ) \leq {θ}_{max} \qquad ( 43 )$$

Herein, it is shown that the voltage angle constraint can be readily incorporated in the proposed formulation without loss of generality. By taking the tangent of the inequality constraint from Constraint (43), it can be converted to two linear equivalent constraints given in terms of real and imaginary voltages at a bus:

V_{I}^{k}−V_{R}^{k} tan θₘₐₓ≤0 (44)

V_{R}^{k} tan θₘᵢₙ−V_{I}^{k}≤0 (45)

### II. E. iv Transmission Line Inequality Constraints:

The first transmission line thermal constraint defined by the upper bound of the maximum apparent power can be converted to the maximum current limit that is allowed to flow in the line. This constraint formed as a maximum current limit is trivially handled by the split-circuit formulation. If the RL line segment between nodes k and m as the one shown in FIG. 8 is considered, an expression of the maximum current magnitude bound appears in Equation (46):

$${\vert {I}_{km} \vert}_{max} = \frac{{S}_{max}}{{V}_{nom}} \qquad ( 46 )$$

As can be seen from the Equation (46), the transmission line thermal limit will be incorporated in the proposed formulation by setting the upper bound to the transmission line current magnitude:

I_{R,km}²+I_{R,km}²≤Iₖₘ|ₘₐₓ² (47)

wherein I_{R,km} and I_{I,km} are the real and imaginary parts of transmission line current respectively.

The second stability constraint bounds the maximum voltage angle difference between the sending and receiving transmission line terminals, i.e. Vₘ and Vₖ. The voltage drop across the line from FIG. 8 is given by:

(Gₗᵢₙₑ+jBₗᵢₙₑ)[Vₖ cos θₖ−Vₘ cos θₘ+j(Vₖ sin θₖ−Vₘ sin θₘ)]=I_{R,km}+jI_{I,km} (48)

Using the bounds of voltage angle stability constraint from Constraint (7):

θₖ=θₘ±θₘₐₓ (49)

Equation (48) can be further rewritten to obtain the lower and upper bounds on the real and imaginary line currents:

I_{R,km}^{m}=Gₗᵢₙₑ(Vₖ cos [θₘ±θₘₐₓ]−Vₘ cos θₘ)−Bₗᵢₙₑ(Vₖ sin [θₘ±θₘₐₓ]−Vₘ sin θₘ) (50)

I_{I,km}^{m}=Gₗᵢₙₑ(Vₖ sin [θₘ±θₘₐₓ]−Vₘ sin θₘ)+Bₗᵢₙₑ(Vₖ cos [θₘ±θₘₐₓ]−Vₘ cos θₘ) (51)

By using trigonometric identities given in Equations (52) and (53):

cos [a±b]=cos a cos b∓sin a sin b (52)

sin [a±b]=sin a cos b±cos a sin b (53)

the transmission line current bounds from Equations (50) and (51) can be further simplified:

$$\begin{matrix}{I}_{R , km}^{m} = {G}_{line} ( \frac{{V}_{k}}{{V}_{m}} [ {V}_{m}^{R} cos {θ}_{max} ∓ {V}_{m}^{I} sin {θ}_{max} ] - {V}_{m}^{R} ) - {B}_{line} ( \frac{{V}_{k}}{{V}_{m}} [ {V}_{m}^{I} cos {θ}_{max} \pm {V}_{m}^{R} sin {θ}_{max} ] - {V}_{m}^{I} ) & ( 54 ) \\ {I}_{I , km}^{m} = {G}_{line} ( \frac{{V}_{k}}{{V}_{m}} [ {V}_{m}^{I} cos {θ}_{max} \pm {V}_{m}^{R} sin {θ}_{max} ] - {V}_{m}^{I} ) + {B}_{line} ( \frac{{V}_{k}}{{V}_{m}} [ {V}_{m}^{R} cos {θ}_{max} ∓ {V}_{m}^{I} sin {θ}_{max} ] - {V}_{m}^{R} ) & ( 55 )\end{matrix}$$

wherein Vₘ^{R} and Vₘ^{I} are the real and imaginary voltages of the receiving bus m.

In order to ensure that the transmission line current bounds are satisfied for any voltage magnitude within the operating limits, the voltage magnitude of the sending bus, i.e., Vₖ, is set to the minimum voltage limit and the voltage magnitude of the receiving bus, i.e., Vₘ, to the maximum voltage limit. Moreover, if the angle difference, θₘₐₓ, is further set to maximum possible one, i.e., 90°, the lower and upper complex current bounds can be obtained as:

$$\begin{matrix}{I}_{R , km} + {G}_{line} ( \frac{{V}_{min}}{{V}_{max}} {V}_{m}^{I} + {V}_{m}^{R} ) + {B}_{line} ( \frac{{V}_{min}}{{V}_{max}} {V}_{m}^{R} - {V}_{m}^{I} ) \leq 0 & ( 56 ) \\ - {I}_{R , km} + {G}_{line} ( \frac{{V}_{min}}{{V}_{max}} {V}_{m}^{I} - {V}_{m}^{R} ) + {B}_{line} ( \frac{{V}_{min}}{{V}_{max}} {V}_{m}^{R} + {V}_{m}^{I} ) \leq 0 & ( 57 ) \\ {I}_{I , km} + {G}_{line} ( \frac{{V}_{min}}{{V}_{max}} {V}_{m}^{R} + {V}_{m}^{I} ) - {B}_{line} ( \frac{{V}_{min}}{{V}_{max}} {V}_{m}^{I} - {V}_{m}^{R} ) \leq 0 & ( 58 ) \\ - {I}_{I , km} - {G}_{line} ( \frac{{V}_{min}}{{V}_{max}} {V}_{m}^{R} - {V}_{m}^{I} ) + {B}_{line} ( \frac{{V}_{min}}{{V}_{max}} {V}_{m}^{I} + {V}_{m}^{R} ) \leq 0 & ( 59 )\end{matrix}$$

The SCOPF formulations (mentioned above and described below) also require adding new control variables such as controllable shunt or series elements of a transmission lines, as well as the transformer turns ratio and shift angle. It is further shown that the proposed formulation can inherently incorporate all of these constraints without loss of generality.

### II. E. v Variable Shunt Limits:

Consider a shunt element connected to a bus m as shown in FIG. 9. Similar to the linear pi-model for a transmission where the shunt values are known, the split circuit equations can be given in terms of real and imaginary currents flowing through the shunt element:

Iₛₕ^{R}=GₛₕVₘ^{R}−BₛₕVₘ^{I} (60)

Iₛₕ^{I}=GₛₕVₘ^{I}+BₛₕVₘ^{R} (61)

Furthermore, since the shunt values are treated as a control variables, the current source model as given in Equations (60) and (61) becomes a bilinear model and allows the application of McCormick convex envelope relaxation. Moreover, the two bounding constraints have to be added that limit the newly introduced control variables, Gₛₕ and Bₛₕ.

Gₘᵢₙ≤Gₛₕ≤Gₘₐₓ (62)

Bₘᵢₙ≤Bₛₕ≤Bₘₐₓ (63)

### II. E. vi Variable Series Element Limits:

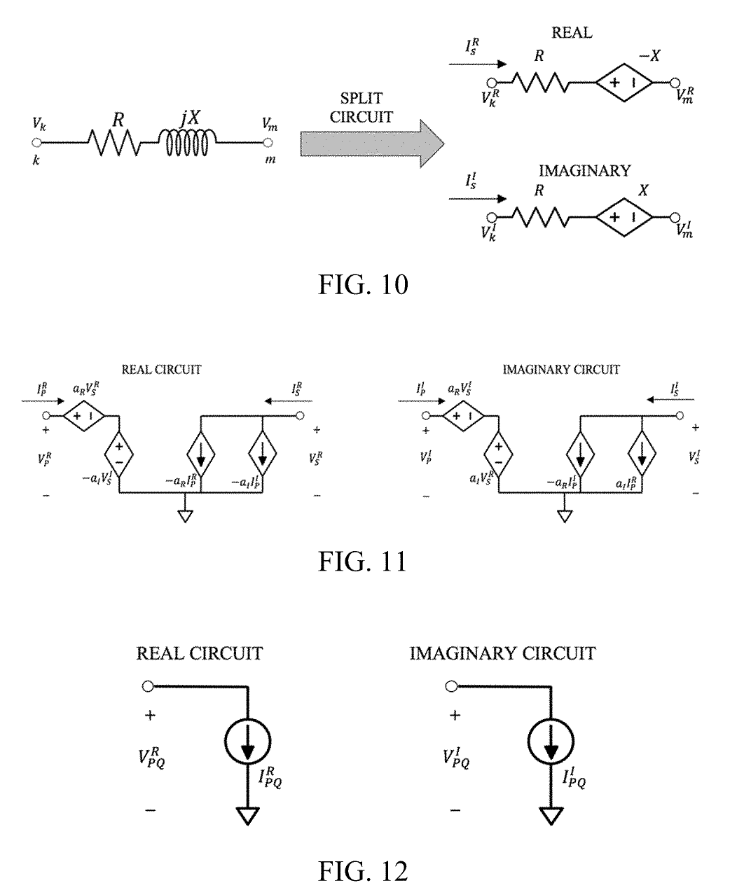

In order to obtain the bilinear expressions in terms of line resistance and reactance that can be suitable for application of McCormick convex envelope relaxation the controllable series elements are remodeled as a voltage sources as shown in FIG. 10.

As it can be seen from FIG. 10, the real and imaginary circuits of a controllable series element are coupled with current controlled voltage sources. Moreover, the governing split-circuit bilinear equations may be given as:

Vₘ^{R}−Vₖ^{R}=RIₛ^{R}−XIₛ^{I} (64)

Vₘ^{I}−Vₖ^{I}=RIₛ^{I}+XIₛ^{R} (65)

Furthermore, the two bounding constraints have to be added that limit the newly introduced control variables, R and X.

Rₘᵢₙ≤R≤Rₘₐₓ (66)

Xₘᵢₙ≤X≤Xₘₐₓ (67)

It is important to note that as in the other circuit models introduced, the controllable series element circuit model is defined by a bilinear function, hence a McCormick relaxation can be efficiently applied, as thoroughly explained in the following sections.

### II. E. vii Transformer Limits:

It is illustrated herein how a two-winding transformer with a possible phase shift can be incorporated in the proposed formulation. For a given transformer turns ratio a and a phase sifting angle θₚₕ the complex number (Equation (68)) that relates the voltages/currents from the primary side to the ones on the secondary side can be obtained as:

ã=ae^{jθph}=a_{R}+ja_{I} (68)

wherein a_{R} and a_{I} are real and imaginary parts of ã.

It is noted that herein the transformer control variables are treated as continuous, whereas the closest integer value for both turns ratio and shift angle is chosen after the optimal parameters of the power grid are computed. Importantly, the class of relaxation method used in some examples herein, i.e., McCormick relaxation, can be further extended to the integer variable and as such handle the integer constraints on the transformer control variables, which further yield Mixed-Integer Programming (MIP). The complete equivalent split-circuit is shown in FIG. 11. Using the rectangular expression from Equation (68), the split circuit governing equations for primary and secondary sides of a two-winding transformer can be expressed as:

V_{P}^{R}=a_{R}V_{S}^{R}−a_{I}V_{S}^{I} (69)

V_{P}^{I}=a_{R}V_{S}^{I}+a_{I}V_{S}^{R} (70)

I_{S}^{R}=−a_{R}I_{P}^{R}−a_{I}I_{P}^{I} (71)

I_{S}^{I}=−a_{R}I_{P}^{I}+a_{I}I_{P}^{R} (72)

wherein subscripts P and S stand for primary and secondary side voltages and currents respectively.

As it can be seen from Equations (69)-(72), all the introduced nonlinearities of the transformer model are bilinear functions, hence an efficient McCormick relaxation can be applied. Moreover, in order to incorporate the transformer bounds in terms of newly introduced state variables, i.e. a_{R} and a₁ the bounds of turns ratio and the transformer shift angle can be reformulated as:

aₘᵢₙ²≤a_{R}²+a_{I}²≤aₘₐₓ² (73)

a_{I}−a_{R} tan θₘₐₓ≤0 (74)

a_{R} tan θₘᵢₙ−a_{I}≤0 (75)

wherein θₘₐₓ, θₘᵢₙ, aₘₐₓ and aₘᵢₙ are the upper and lower bounds of the transformer shift angle and the turns ratio respectively.

### II. F Load Bus Models

The introduced invention provides the capabilities of incorporating the traditionally used PQ based loads. In order to remodel the PQ load in a way that its governing equations can be represented with bilinear nonlinearities, the PQ load is modeled as real and imaginary current sources in respective sub circuits of a split-circuit, as shown in FIG. 11. Furthermore, for each of the current sources state variables an equality constraint, i.e., Equations (76) and (77), needs to be added to constraint real and reactive powers delivered to the load.

I_{PQ}^{R}d_{sq}−PV_{PQ}^{R}−QV_{PQ}^{I}=0 (76)

I_{PQ}^{I}d_{sq}−PV_{PQ}^{I}+QV_{PQ}^{R}=0 (77)

wherein V is the voltage magnitude of a load bus and P and Q are constant values of real and reactive powers. As can be seen from Equations (76) and (77), the introduced equality constraints are based on the bilinear nonlinearity of a form XY, thus the McCormick relaxation can be applied.

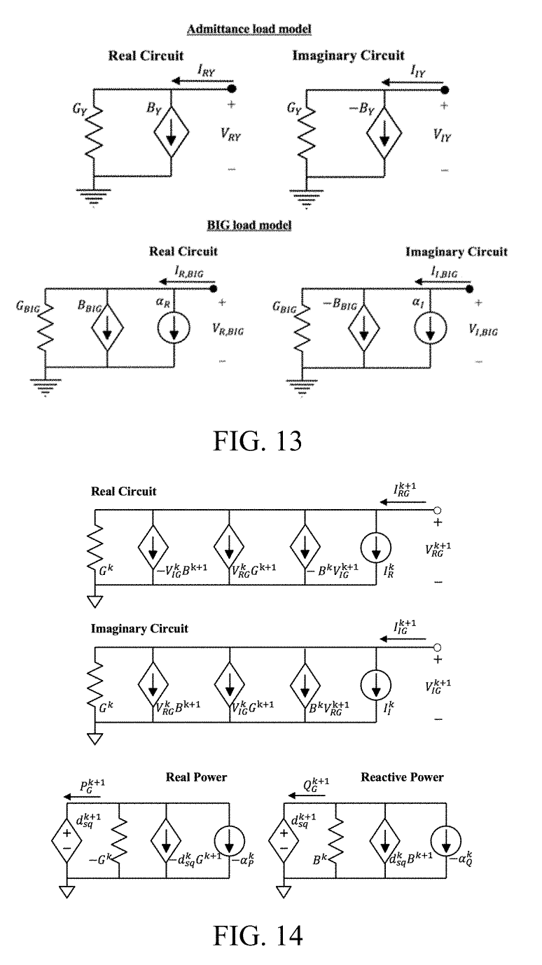

It is important noting that a PQ load model adds a lot complexity to the overall optimization problem by introducing additional bilinear nonlinearities. Conversely, linear BIG and admittance models, for which the equivalent split-circuits are shown in FIG. 13, are proven to more accurately capture the actual load behavior as compared to the traditional load models, since they capture some voltage dependence while the PQ load model does not. In addition to the accuracy, BIG models are linear with the proposed equivalent split-circuit formulation, hence they significantly decrease the complexity of the circuit equations used as an equivalent constraint for optimal power flow.

### II. G McCormick Convex Envelope Relaxation

As can be seen from previously derived equivalent circuit models, there are two types of nonlinearities that appear throughout the formulation. These nonlinearities can generally be expressed in forms of two sets of bilinear and quadratic functions, Equations (78) and (79), respectively, given as:

[symbol]

₁={(X₁,Y₁,c₁)ϵ[lₓ₁,uₓ₁]×[l_{y1},u_{y1}]× [symbol] |c₁=X₁Y₁} (78)

[symbol]

₂={(X₂,Y₂,c₂)ϵ[lₓ₂,uₓ₂]×[l_{y2},u_{y2}]× [symbol] ↑c₂=Y₂²} (79)

for the set in which X₁, Y₁, and Y₂ can be the state and control variables introduced in the formulation bounded by lower and upper limits given by [lₓᵢ, uₓᵢ] and [l_{yj}, u_{yj}].

The form of introduced nonlinearities allows us to efficiently apply McCormick convex envelope relaxation, which represents the most common convex relaxations technique for the bilinear functions in global optimization programs. The nonlinear sets defined in Equations (78) and (79) can be relaxed by introducing the McCormick envelopes, i.e., MC_{[l}_{ₓᵢ}_{,u}_{ₓᵢ}_{]×[l}_{_{yj}}_{,u}_{_{yj}}_{]} (Xᵢ, Yⱼ) that also represent the convex hulls for each of the defined sets:

$$\begin{matrix}{MC}_{[ {l}_{x 1} , {u}_{x 1} ] \times [ {l}_{y 1} , {u}_{y 1} ]} ( {X}_{1} , {Y}_{1} ) = \{ \begin{matrix}{c}_{1} \geq {l}_{x 1} {Y}_{1} + {X}_{1} {l}_{y 1} - {l}_{x 1} {l}_{y 1} \\ {c}_{1} \geq {u}_{x 1} {Y}_{1} + {X}_{1} {u}_{y 1} - {u}_{x 1} {u}_{y 1} \\ {c}_{1} \leq {u}_{x 1} {Y}_{1} + {X}_{1} {l}_{y 1} - {u}_{x 1} {l}_{y 1} \\ {c}_{1} \leq {X}_{1} {u}_{y 1} + {l}_{x 1} {Y}_{1} - {l}_{x 1} {u}_{y 1}\end{matrix} & ( 80 ) \\ {MC}_{[ {l}_{y 2} , {u}_{y 2} ] \times [ {l}_{y 2} , {u}_{y 2} ]} ( {Y}_{2} ) = \{ \begin{matrix}{c}_{2} \geq 2 {l}_{y 2} {Y}_{2} - {( {l}_{y 2} )}^{2} \\ {c}_{2} \geq 2 {u}_{y 2} {Y}_{2} - {( {u}_{y 2} )}^{2} \\ {c}_{2} \leq ( {u}_{y 2} + {l}_{y 2} ) {Y}_{2} - {u}_{y 2} {l}_{y 2}\end{matrix} & ( 81 )\end{matrix}$$

II. I Sequential Quadratic Programming in terms of Equivalent Circuits

Sequential Quadratic Programming (SQP) is an effective technique for solving the optimization problems and it is preferred over the Interior Point Methods (IPM) when a good estimate of the solution is available. Herein, it is shown how the complete optimization program solved using the Sequential Quadratic Programming (SQP) can be modeled as an equivalent circuit problem without loss of generality, thereby allowing the application of circuit simulation methods for robust solution convergence, such as Homotopy and Continuation algorithms.

Consider the generalized optimization problem given as:

$$\begin{matrix}{min}_{X} {ℱ}_{cost} ( X ) \\ s . t . & ( 82 ) \\ h ( X ) = 0 & ( 83 ) \\ g ( X ) \leq 0 & ( 84 )\end{matrix}$$

wherein Xϵ [symbol] ⁿ is the vector of optimization variables, [symbol] _{cost}: [symbol] ⁿ→ [symbol] is the objective cost function that is to be minimized, functions h: [symbol] ⁿ→ [symbol] and g: [symbol] ⁿ→ [symbol] , describe equality and inequality constraints respectively. The optimization problem defined by (83) to (84) will be solved using SQP by constructing the quadratic sub-problem that will be solved iteratively until the convergence to the desired minimum.

To construct the quadratic sub-problem in general, the cost function in (82) is replaced by its local quadratic approximation. It is noted that the preferred formulation for methods of the present invention already uses the quadratic cost functions; i.e., quadratic functions of generator powers or respective conductance/susceptance state variables, hence the aforementioned approximation is not needed. Moreover, the equality and inequality constraint given by Constraint (83) and (84) are linearized with respect to the current iterate vector X^{k} and hence can be reformulated as:

h(X^{k})+∇h(X^{k})^{T}(X^{k+1}−X^{k})=0 (85a)

g(X^{k})+∇g(X^{k})^{T}(X^{k+1}−X^{k})≤0 (85b)

Using the defined quadratic sub-problem, the Lagrangian function can further be written as:

[symbol]

= [symbol] _{cost}(X^{k+1})+λ^{T}(h(X^{k})+∇h(X^{k})^{T}(X^{k+1}−X^{k}))+μ^{T}(g(X^{k})+∇g(X^{k})^{T}(X^{k+1}−X^{k})+s) (86)

wherein X^{k+1} is a vector of state variables, X^{k} are the solutions from previous iteration, λ, μ are Lagrange multipliers of the equality and inequality constraints respectively, and s is the vector of slack variables, i.e. sϵ [symbol] ⁺, added to handle the inequality constraints

In order to ensure the numerical stability of the derived quadratic sub-problem, the second order sensitivities of the Lagrangian function are added to the cost function from (82) yielding the modified Quadratic Programming problem given as:

$${min}_{X} ∇ {{ℱ}_{cost} ( {X}^{k} )}^{T} {X}^{k + 1} + \frac{1}{2} {( {X}^{k + 1} - {X}^{k} )}^{T} {∇}_{XX}^{2} ℒ ( {X}^{k} , {λ}^{k} , {μ}^{k} , s ) ( {X}^{k + 1} - {X}^{k} ) \qquad ( 87 )$$

with respect to the linearized constraints given by (85a)-(85b).

Furthermore, the optimal solution of the defined quadratic program is guaranteed if the first-order necessary conditions, i.e. Karush-Kuhn-Tucker (KKT) conditions, are satisfied. Hence, the respective KKT conditions can be rewritten as:

$$\begin{matrix}\frac{\partial ℒ}{\partial {X}^{k + 1}} = ∇ {ℱ}_{cost} ( {X}^{k} ) + {∇}_{XX}^{2} {ℒ}^{k} ( {X}^{k + 1} - {X}^{k} ) + ∇ {h ( {X}^{k} )}^{T} λ + ∇ {g ( {X}^{k} )}^{T} μ = 0 & ( 88 ) \\ \frac{\partial ℒ}{\partial λ} = h ( {X}^{k} ) + ∇ {h ( {X}^{k} )}^{T} ( {X}^{k + 1} - {X}^{k} ) = 0 & ( 89 ) \\ \frac{\partial ℒ}{\partial μ} = g ( {X}^{k} ) + ∇ {g ( {X}^{k} )}^{T} ( {X}^{k + 1} - {X}^{k} ) + s = 0 & ( 90 ) \\ \frac{\partial ℒ}{\partial s} = 0 & ( 91 )\end{matrix}$$

It is noted that solution for the system of equations from (88) to (91) represents the solution to a quadratic sub-problem defined by (82), (85), and (86). The SQP algorithm is based on iteratively solving the aforementioned quadratic problems until the convergence; i.e. max(X^{k+1}−X^{k})<ε, wherein ε is predefined tolerance.

In the following subsections, it is shown how the previously defined optimization program can be modeled as an equivalent circuit for both nonlinear Full-OPF and GB-OPF, without loss of generality. Importantly, the equivalent circuit formulation allows the application of various Homotopy and continuation methods that can be used to guarantee robust and efficient convergence properties. It is noted that since there are many methods of handling the inequality constraints, such as the Interior Point method, Active Set method, etc., the equivalent split circuits are derived for Equations (88) and (89) only. Moreover, depending on the method used to handle the inequalities of the program, further derivation of linear equivalent circuit that describe Equations (90) and (91) directly follows.

### II. J Nonlinear Full Optimal Power Flow (AC-OPF)

### II. J. i PV Generator

The governing equations of a PV generator split circuit model, as well as the generalized real and reactive power cost function that is to be minimized are given by Equations (22), (23), and (33) respectively. Furthermore, since both real and reactive powers are added as the state variables, there are two appended additional constraints that define the relationship between the respective powers and conductance and susceptance state variables, i.e., Equations (24) and (29). To obtain the equivalent circuits that satisfy the KKT conditions from Equation (89) the governing Equations (22) and (23), as well as the respective constraints, i.e., Equations (24) and (29), are linearized using the first order Taylor expansion:

$$\begin{matrix}{I}_{RG}^{k + 1} = \frac{\partial {I}_{RG}}{\partial B} {\vert}^{k} ( {B}^{k + 1} ) + \frac{\partial {I}_{RG}}{\partial G} {\vert}^{k} ( {G}^{k + 1} ) + \frac{\partial {I}_{RG}}{\partial {V}_{RG}} {\vert}^{k} ( {V}_{RG}^{k + 1} ) + \frac{\partial {I}_{RG}}{\partial {V}_{IG}} {\vert}^{k} ( {V}_{IG}^{k + 1} ) + {I}_{RG}^{k} - \frac{\partial {I}_{RG}}{\partial B} {\vert}^{k} ( {B}^{k} ) - \frac{\partial {I}_{RG}}{\partial G} {\vert}^{k} ( {G}^{k} ) - \frac{\partial {I}_{RG}}{\partial {V}_{RG}} {\vert}^{k} ( {V}_{RG}^{k} ) - \frac{\partial {I}_{RG}}{\partial {V}_{IG}} {\vert}^{k} ( {V}_{IG}^{k} ) & ( 92 ) \\ {I}_{IG}^{k + 1} = \frac{\partial {I}_{IG}}{\partial B} {\vert}^{k} ( {B}^{k + 1} ) + \frac{\partial {I}_{IG}}{\partial G} {\vert}^{k} ( {G}^{k + 1} ) + \frac{\partial {I}_{IG}}{\partial {V}_{RG}} {\vert}^{k} ( {V}_{RG}^{k + 1} ) + \frac{\partial {I}_{IG}}{\partial {V}_{IG}} {\vert}^{k} ( {V}_{IG}^{k + 1} ) + {I}_{IG}^{k} - \frac{\partial {I}_{IG}}{\partial B} {\vert}^{k} ( {B}^{k} ) - \frac{\partial {I}_{IG}}{\partial G} {\vert}^{k} ( {G}^{k} ) - \frac{\partial {I}_{IG}}{\partial {V}_{RG}} {\vert}^{k} ( {V}_{RG}^{k} ) - \frac{\partial {I}_{IG}}{\partial {V}_{IG}} {\vert}^{k} ( {V}_{IG}^{k} ) & ( 93 ) \\ {P}_{G}^{k + 1} = - {d}_{sq}^{k} {G}^{k + 1} - {G}^{k} {d}_{sq}^{k + 1} + {d}_{sq}^{k} {G}^{k} & ( 94 ) \\ {Q}_{G}^{k + 1} = {d}_{sq}^{k} {B}^{k + 1} + {B}^{k} {d}_{sq}^{k + 1} - {d}_{sq}^{k} {B}^{k} & ( 95 )\end{matrix}$$

As can be seen from Equations (92) and (93), the first two terms of linearized real and imaginary currents, represent current sources that are function of newly introduced conductance and susceptance state variables. Further, the terms that are proportional to the voltage across them, can be represented by the conductance defined by the values of respective partial derivatives, while the terms that are proportional to the voltage across the other circuit are represented by voltage controlled current sources. Lastly, the remaining terms are all dependent on known values from the previous k^{th}SQP iteration, so they can be lumped together and represented as an independent current source, i.e. I_{R}^{k} and I_{I}^{k}. The complete equivalent split circuit of Equations (92) and (93) that further models ∇_{λ} [symbol] part of KKT conditions, i.e., Equation (89), is shown in FIG. 14. It is noted that Equations (94) and (95) can be also seen as an equivalent circuit, wherein the first terms represent the current sources controlled by the conductance and susceptance of the generator equivalent circuit. The second terms are represented by a conductance since the current in the branch is proportional to the voltage determined by the voltage controlled voltage source d_{sq}^{k+1}. In addition, the values dependent on the known values can be lumped together and represented by an independent current source. Note that values of the current supplied by the voltage controlled voltage sources (d_{sq}^{k+1}) are equivalent to the values of real and reactive powers respectively.

In order to obtain the equivalent circuit of a PV generator that satisfies the KKT conditions given by Equation (88), the Lagrangian function is differentiated from Equation (87) with respect to the state and control variables of a respective PV generator. This further yields the four additional governing equations in terms of Lagrange multipliers given as:

$$\begin{matrix}{RG}_{} = \frac{\partial {I}_{RG}}{\partial {V}_{RG}} {\vert}^{k} {λ}_{RG} - \frac{\partial {I}_{RG}}{\partial {V}_{IG}} {\vert}^{k} {λ}_{IG} + {ξ}_{RG} ( G , B , {V}_{RG} , {V}_{IG} ) + {\overline{ξ}}_{RG} & ( 96 ) \\ {IG}_{} = \frac{\partial {I}_{IG}}{\partial {V}_{IG}} {\vert}^{k} {λ}_{IG} - \frac{\partial {I}_{IG}}{\partial {V}_{RG}} {\vert}^{k} {λ}_{RG} + {ξ}_{IG} ( G , B , {V}_{RG} , {V}_{IG} ) + {\overline{ξ}}_{IG} & ( 97 ) \\ {μ}_{{P}_{max}} - {μ}_{{P}_{min}} - \frac{{V}_{RG}^{k}}{{d}_{sq}^{k}} {λ}_{RG} - \frac{{V}_{IG}^{k}}{{d}_{sq}^{k}} {λ}_{IG} + \frac{\partial {ℱ}_{cost , i}}{\partial {P}_{G , i}^{k + 1}} + {ξ}_{PG} ( {V}_{RG} , {V}_{IG} , {d}_{sq} ) + {\overline{ξ}}_{PG} = 0 & ( 98 ) \\ \frac{\partial {ℱ}_{cost , i}}{\partial {Q}_{G , i}^{k + 1}} + {μ}_{{Q}_{max}} - {μ}_{{Q}_{min}} - \frac{{V}_{IG}^{k}}{{d}_{sq}^{k}} {λ}_{RG} + \frac{{V}_{RG}^{k}}{{d}_{sq}^{k}} {λ}_{IG} + {ξ}_{QG} ( {V}_{RG} , {V}_{IG} , {d}_{sq} ) + {\overline{ξ}}_{QG} = 0 & ( 99 )\end{matrix}$$

wherein λ_{RG} and λ_{IG} are the Lagrange multipliers related to the real and imaginary generator voltages, respectively, bₚ, cₚ, b_{Q} and c_{Q} are the coefficients of real and reactive generated power, i.e., P_{G} and Q_{G}, cost functions, μ_{Pmax}, μ_{Pmin}, μ_{Qmax} and μ_{Qmin} are Lagrange multipliers related to the limits of the real and reactive powers generated and ξ(X) and ξ̅ are the second order sensitivities and their historic terms respectively.

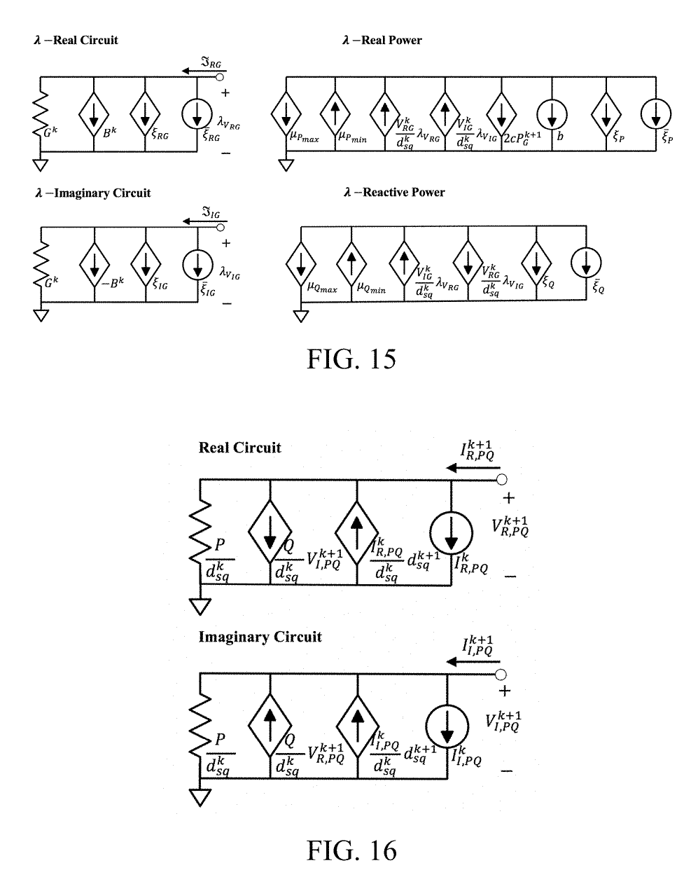

As can be seen from Equations (96) and (97), the terms wherein the real and imaginary Lagrange currents, i.e. ℑ_{RG} and ℑ_{IG} are respectively proportional to the Lagrange multipliers related to the real and imaginary voltages, can be represented with a conductance. On the other side, the terms proportional to the Lagrange multipliers related voltages of the other circuit are represented by voltage controlled current sources. The complete equivalent circuit of Equations (96) and (97) that further models the PV generator for ∇_{λ} [symbol] part of KKT conditions given by Equation (88), is shown in FIG. 15. Also, the equations (98) and (99) are the additional constraints related to the real and reactive generated powers, hence will be appended to the system of circuit equations. Lastly, it should be noted that all of the second order sensitivities from (96)-(99) are represented as controlled current sources, while the corresponding historic terms that are known from the previous SQP iteration are lumped together and represented by a constant current sources.

### II. J. ii PQ Load Model

The governing equations of a PQ load split circuit model are given in Equations (76) and (77). To obtain the equivalent circuits that satisfy the KKT conditions from Equation (89), the governing equations of a PQ load are linearized using the first order Taylor expansion:

$$\begin{matrix}{I}_{R , PQ}^{k + 1} = \frac{P}{{d}_{sq}^{k}} {V}_{R , PQ}^{k + 1} + \frac{Q}{{d}_{sq}^{k}} {V}_{I , PQ}^{k + 1} - \frac{{I}_{R , PQ}^{k}}{{d}_{sq}^{k}} {d}_{sq}^{k + 1} + {I}_{R , PQ}^{k} & ( 100 ) \\ {I}_{I , PQ}^{k + 1} = \frac{P}{{d}_{sq}^{k}} {V}_{I , PQ}^{k + 1} - \frac{Q}{{d}_{sq}^{k}} {V}_{R , PQ}^{k + 1} - \frac{{I}_{I , PQ}^{k}}{{d}_{sq}^{k}} {d}_{sq}^{k + 1} + {I}_{I , PQ}^{k} & ( 101 )\end{matrix}$$

As can be seen from Equations (100) and (101), terms that are proportional to the voltage across them, can be represented by the conductance, while the terms that are proportional to the voltage across the other circuit or the voltage magnitude are represented by voltage controlled current sources. In addition, the remaining terms are all dependent on known values from the previous k^{th}SQP iteration, so they can be represented as an independent current source. The complete equivalent circuit that maps Equations (100) and (101) and further models ∇_{λ} [symbol] part of KKT conditions, i.e., Equations (92), is shown in FIG. 16.

To obtain the equivalent circuit of a PQ load that satisfies the KKT conditions given by Equation (88), the Lagrangian function from Equation (87) is differentiated with respect to the state and control variables of a respective PQ load. This further yields the governing equations in terms of Lagrange multipliers given as:

$$\begin{matrix} & ( 102 ) \\ & ( 103 )\end{matrix}$$

Wherein λ_{RL} and λ_{IL} are the Lagrange multipliers related to the real and imaginary PQ load voltages, while ξ(X) and ξ̅ are the second order sensitivities and their historic terms respectively.

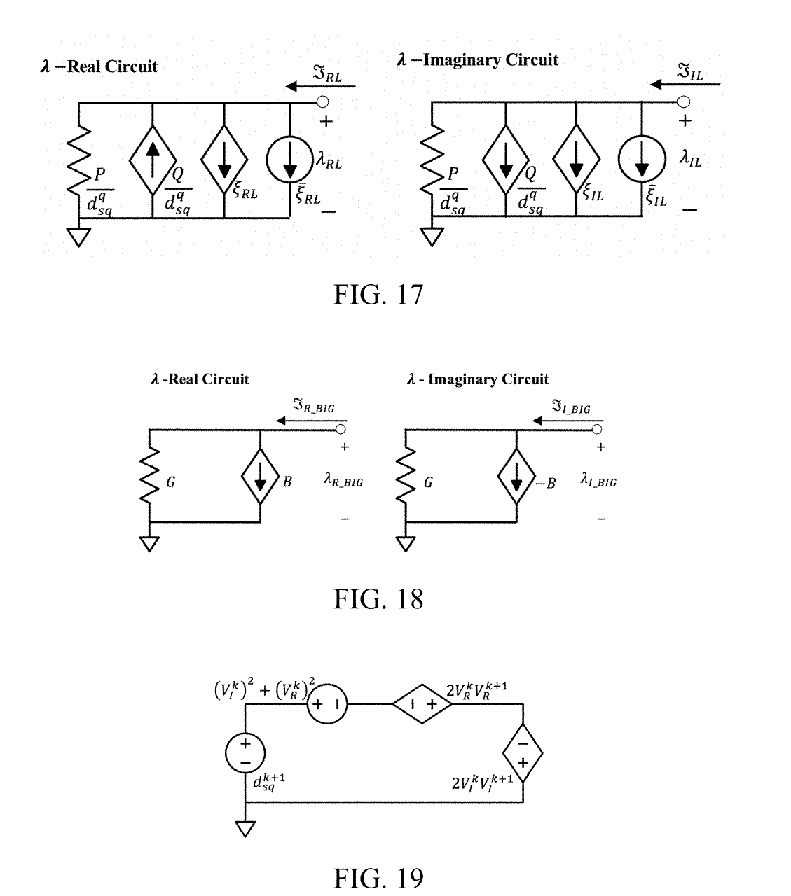

As can be seen from Equations (102) and (103), the terms wherein the real and imaginary Lagrange currents, i.e. ℑ_{RL} and ℑ_{IL}, are respectively proportional to the Lagrange multipliers related to the real and imaginary voltages, can be represented with a conductance. On the other side, the terms proportional to the Lagrange multipliers related voltages of the other circuit are represented by voltage controlled current sources. The second order sensitivities ξ_{RL}(V_{RL}, V_{IL}, d_{sq}) and ξ_{IL}(V_{RL}, V_{IL}, d_{sq}) are represented by controlled current sources, while their historic constant terms are represented by the constant current sources. The complete equivalent circuit of Equations (102) and (103) that further models the PQ load for ∇_{λ} [symbol] part of KKT conditions given by Equation (88) is shown in FIG. 17.

### II. J. iii BIG Load Model

The governing equations of the BIG load model, whose equivalent split circuit is shown in FIG. 3, are given as:

I_{R}_{_}_{BIG}=GV_{RL}−BV_{IL}+α_{R} (104)

I_{I}_{_}_{BIG}=BV_{RG}+GV_{IG}+α_{I} (105)

wherein G, B, α_{R}, and α_{I} are known conductance, susceptance and current parameters of the load. It is noted that Equations (104) and (105) are linear, hence map the equivalent circuit that further model ∇_{λ} [symbol] part of KKT conditions, i.e., Equation (89).

Similarly as in the PQ load modeling, to obtain the equivalent circuit of a BIG load that satisfies the KKT conditions given by Equation (88), the Lagrangian function from Equation (87) is differentiated with respect to the state and control variables of a respective BIG load model. This further yields the governing equations in terms of Lagrange multipliers given as:

ℑ_{R}_{_}_{BIG}=Gλ_{R}_{_}_{BIG}+Bλ_{I}_{_}_{BIG} (106)

ℑ_{I}_{_}_{BIG}=Gλ_{I}_{_}_{BIG}−Bλ_{R}_{_}_{BIG} (107)

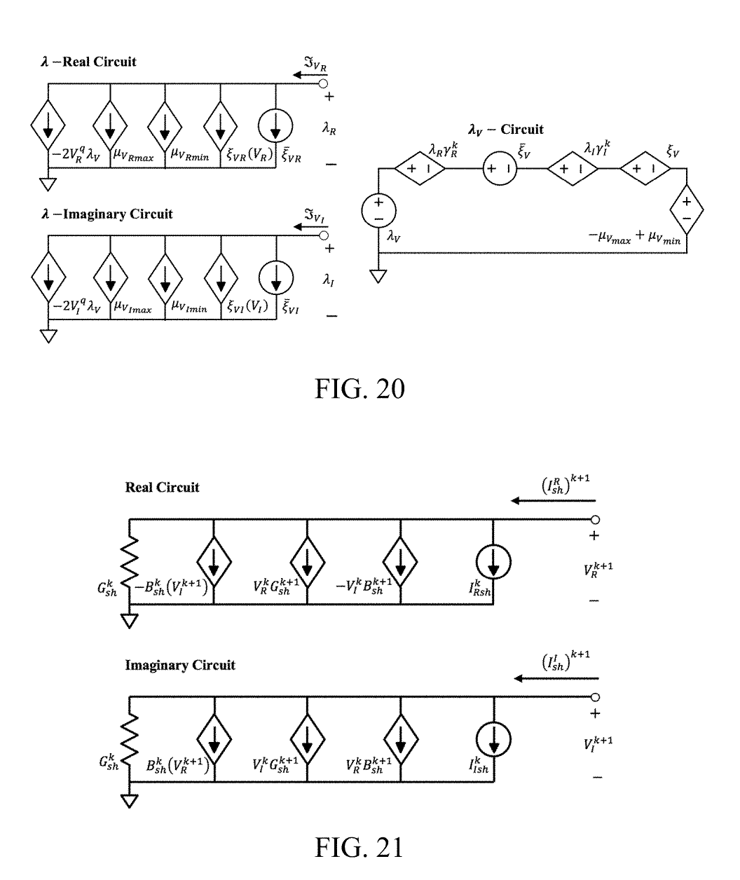

As can be seen from Equations (106) and (107), the terms wherein the real and imaginary Lagrange currents, i.e. ℑ_{R}_{_}_{BIG} and ℑ_{I}_{_}_{BIG}, are respectively proportional to the Lagrange multipliers related to the real and imaginary voltages, can be represented with a conductance. On the other side, the terms proportional to the Lagrange multipliers related voltages of the other circuit are represented by voltage controlled current sources. The equivalent split circuit that further models the BIG load for ∇_{λ} [symbol] part of KKT conditions given by Equation (88) is shown in FIG. 18.

### III. C. iv Voltage Magnitude Constraint

The OPF analysis limits the voltage magnitudes at each bus to ensure that the optimized system operates around the nominal voltage point. In addition to the voltage magnitude limits, the proposed invention adds the limits on both real and imaginary voltages that will further reduce the bounds around the global optimal solution.

The equality constraint added to define the bus voltage magnitude in terms of its real and imaginary parts, i.e. Equation (35), represents a nonlinear quadratic constraint, hence it is linearized using the first order Taylor expansion:

d_{sq}^{k+1}=2V_{R}^{k}V_{R}^{k+1}+2V_{I}^{k}V_{I}^{k+1}−(V_{I}^{k})²−(V_{R}^{k})² (108)

wherein d_{sq}, V_{R} and V_{I} are bus variable related to voltage magnitude as well as real and imaginary voltages, respectively.

Representing constraints as an equivalent circuit model will enable the formulation of the optimization program to be equivalent to the solution of an equivalent circuit model. As can be seen from Equation (108) the terms wherein the bus voltage magnitude is proportional to real and imaginary bus voltages can be represented by a voltage controlled voltages sources, while the term proportional to the values from previous SQP iteration is represented as an independent voltage source. The complete equivalent circuit that maps Equation (108) and further models ∇_{λ} [symbol] part of KKT conditions, i.e., Equation (89), is shown in FIG. 19.

Let N_{G} be the number of the generators connected to a bus. Moreover, let an aggregated PQ load be connected to the same bus. To obtain the equivalent circuit of a voltage constraint that satisfies the KKT conditions given by Equation (88), the Lagrangian function from Equation (87) is differentiated with respect to the state and control variables of a respective N_{G} generators and aggregated load. This further yields the governing equations in terms of Lagrange multipliers given as:

ℑ_{VR}=−2V_{R}^{k}λ_{V}+μ_{VRmax}−μ_{VRmin}+ξ_{VR}(V_{R})+ξ̅_{VR} (109)

ℑ_{VI}=−2V_{I}^{k}λ_{V}+μ_{VImax}−μ_{VImin}+ξ_{VI}(V_{I})+ξ̅_{VI} (110)

λ_{V}=λ_{R}γ_{R}^{k}+λ_{I}γ_{I}^{k}−μ_{V}_{ₘₐₓ}+μ_{V}_{ₘᵢₙ}+ξ_{V}(V_{R},V_{I},G,B,d_{sq})+ξ̅_{V} (111)

wherein μ_{VRmax}, μ_{VRmin}, μ_{VImax}, μ_{VImin}, μ_{Vmax} and μ_{Vmin} are Lagrange multipliers related to the limits of real, imaginary and voltage magnitude at a bus, λ_{RB}, λ_{IB} and λ_{V}, Lagrange multipliers related to the real, imaginary and voltage magnitude respectively, ξ_{VR}(V_{R}), ξ_{VI}(V_{I}), ξ_{V}(V_{R}, V_{I}, G, B, d_{sq}), ξ̅_{VR}, ξ̅_{VI} and ξ̅_{V} represent the second order sensitivities and their historic terms related to the voltage magnitude constraint respectively, while γ_{R}^{k} and γ_{I}^{k} are constants given as:

$$\begin{matrix}{γ}_{R}^{k} = \frac{1}{{d}_{sq}^{k}} [ - {V}_{R}^{k} ( {\sum }_{i = 1}^{{N}_{G}} {G}_{i}^{k} ) + {V}_{I}^{k} ( {\sum }_{i = 1}^{{N}_{G}} {B}_{i}^{k} ) - {( {I}_{PQ}^{R} )}^{k} ] & ( 112 ) \\ {γ}_{I}^{k} = \frac{1}{{d}_{sq}^{k}} [ - {V}_{I}^{k} ( {\sum }_{i = 1}^{{N}_{G}} {G}_{i}^{k} ) - {V}_{R}^{k} ( {\sum }_{i = 1}^{{N}_{G}} {B}_{i}^{k} ) - {( {I}_{PQ}^{I} )}^{k} ] & ( 113 )\end{matrix}$$

As can be seen from Equations (109) and (110), the term dependent on the Lagrangian multiplier is related to the voltage magnitude, and the Lagrange multipliers are related to the minimum and maximum bounds of the real and imaginary voltages respectively, that are represented as a controlled current sources. On the other side, the terms in Equation (111) that are dependent on the real and imaginary bus voltages are represented with voltage controlled voltage sources, while the last term dependent on Lagrange multipliers related to the minimum and maximum voltage magnitude bounds are represented with a current controlled voltage source. Lastly, the second order sensitivities and their corresponding historic terms are represented by controlled current and independent current sources respectively. The complete equivalent split circuit that models the voltage magnitude constraint for the ∇_{λ} [symbol] part of the KKT conditions, as given by Equation (88), is shown in FIG. 20.

### II. J. v Variable Shunt Element

The governing equations of a variable shunt element are given by Equations (60) and (61). To obtain the equivalent circuits that satisfy the KKT conditions from Equation (89) the bilinear governing equations of a variable shunt is linearized using the first order Taylor expansion:

(Iₛₕ^{R})^{k+1}=Gₛₕ^{k}V_{R}^{k+1}−Bₛₕ^{k}V_{I}^{k+1}+V_{R}^{k}Gₛₕ^{k+1}+V_{I}^{k}Bₛₕ^{k+1}−V_{R}^{k}Gₛₕ^{k}+V_{I}^{k}Bₛₕ^{k} (114)

(Iₛₕ^{I})^{k+1}=Bₛₕ^{k}V_{R}^{k+1}+Gₛₕ^{k}V_{I}^{k+1}+V_{I}^{k}Gₛₕ^{k+1}+V_{R}^{k}Bₛₕ^{k+1}−V_{R}^{k}Bₛₕ^{k}−V_{I}^{k}Gₛₕ^{k} (115)

As can be seen from Equations (114) and (115), the first two terms of linearized real and imaginary currents, represent current sources that are function of newly introduced conductance and susceptance control variables. Further, the terms that are proportional to the voltage across them, can be represented by the conductance, while the terms that are proportional to the voltage across the other circuit are represented by voltage controlled current sources. Lastly, the remaining terms are all dependent on known values from the previous k^{th}SQP iteration, so they can be lumped together and represented as an independent current source, i.e. I_{Rsh}^{k} and I_{Ish}^{k}. The complete equivalent split circuit of Equations (114) and (115) that further models ∇_{λ} [symbol] part of KKT conditions, i.e., Equation (89), is shown in FIG. 21.

Similarly, as with the derivation of the other equivalent split circuit models, to obtain the equivalent circuit that represents a variable shunt that satisfies the KKT conditions given by Equation (88), the Lagrangian function from Equation (87) is differentiated with respect to the state and control variables of a shunt element. The governing equations obtained in terms of Lagrange multipliers are then given as:

ℑ_{Rsh}=Gₛₕ^{k}λ_{VR}+Bₛₕ^{k}λ_{VI}+ξ_{Rsh}(Gₛₕ,Bₛₕ)+ξ̅_{Rsh} (116)

ℑ_{Ish}=−Bₛₕ^{k}λ_{VR}+Gₛₕ^{k}λ_{VI}+ξ_{Ish}(Gₛₕ,Bₛₕ)+ξ̅_{Ish} (117)

V_{R}^{k}λ_{VR}+V_{I}^{k}λ_{VI}+μ_{Gmax}−μ_{Gmin}+ξ_{G}(V_{R},V_{I})+ξ̅_{G}=0 (118)

−V_{I}^{k}λ_{VR}+V_{R}^{k}λ_{VI}+μ_{Bmax}−μ_{Bmin}+ξ_{B}(V_{R},V_{I})+ξ̅B=0 (119)

wherein μ_{Gmax}, μ_{Gmin}, μ_{Bmax} and μ_{Bmin} are Lagrange multipliers related to the limits of conductance and susceptance shunt variables, λ_{VR} and λ_{VI} are Lagrange multipliers related to the real and imaginary voltages across the shunt respectively, while ξ_{Rsh}(Gₛₕ,Bₛₕ), ξ_{Ish}(Gₛₕ, Bₛₕ), ξ_{G} (V_{R}, V_{I}) and ξ_{B} (V_{R}, V_{I}) together with the corresponding historic terms (ξ̅_{Rsh}, ξ̅_{Ish}, ξ̅_{G} and ξ̅_{(B)} represent the second order sensitivities of the quadratic SQP sub-problem.

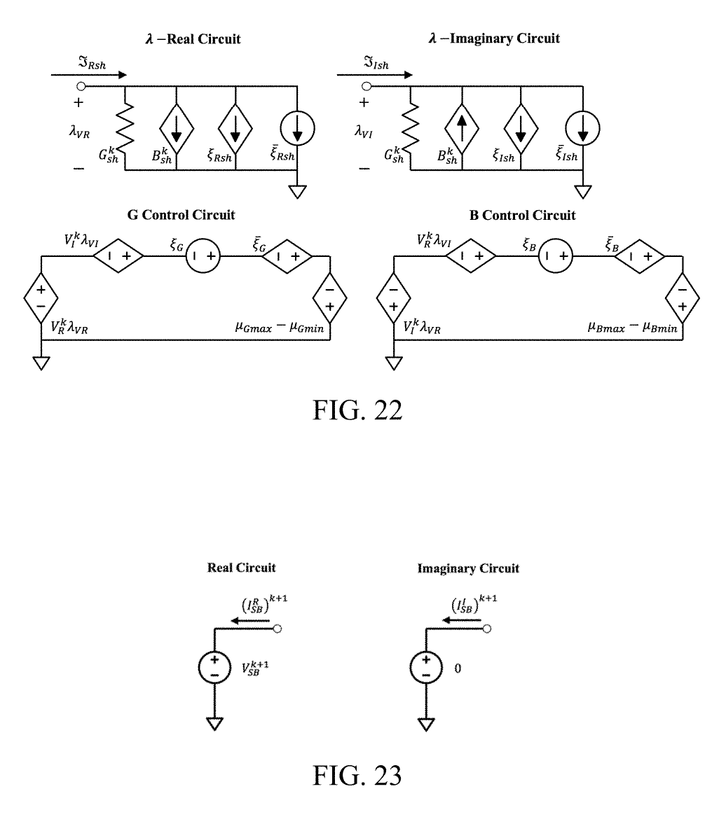

As can be seen from Equations (116) and (117), the terms wherein the real and imaginary Lagrange currents, i.e. ℑ_{Rsh} and ℑ_{Ish}, are respectively proportional to the Lagrange multipliers related to the real and imaginary voltages, and therefore, can be represented with a conductance. The terms proportional to the Lagrange multipliers related voltages of the other circuit are represented by voltage controlled current sources. Furthermore, the second order sensitivities dependent on the powerflow state variables are represented by the controlled current sources, while their corresponding historical terms are represented by the constant current sources. On the other side, Equations (118) and (119) can be seen as loops of voltage sources controlled by Lagrange multipliers related to the real and imaginary voltage and the conductance and susceptance limits. The equivalent split circuit that further models the variable shunt element for ∇_{λ} [symbol] part of KKT conditions given by Equation (88) is shown in FIG. 22.

### II. J. vi Slack Bus Generator

It has been shown that the split-circuit formulation models the slack bus as a voltage source in both real and imaginary circuits. Furthermore, since the reference angle is set to be zero, the voltage source in the imaginary circuit simply becomes a short to ground, i.e., a zero-valued voltage source to ground. Hence, the equivalent split circuit of a slack bus generator that further models ∇_{λ} [symbol] part of KKT conditions, i.e., Equation (89), is shown FIG. 23.

To derive equivalent circuit of a slack bus generator that satisfies the KKT conditions given by Equation (88), the Lagrangian function from Equation (87) is differentiated with respect to the state and control variables of a generator. Governing equations obtained in terms of Lagrange multipliers are further given as:

$$\begin{matrix}{Rsb}_{} = - \frac{{( {I}_{SB}^{R} )}^{k}}{{V}_{SB}^{k}} {λ}_{Vsb} - \frac{{( {I}_{SB}^{I} )}^{k}}{{V}_{SB}^{k}} {λ}_{V 0} + {μ}_{Vmax} - {μ}_{Vmin} + {ξ}_{SB} ( {V}_{SB} , {I}_{SB}^{R} , {I}_{SB}^{I} ) + {\overline{ξ}}_{SB} & ( 120 ) \\ {b}_{P} + 2 {c}_{P} {P}_{SB} - \frac{1}{{V}_{SB}^{k}} {λ}_{Vsb} + {μ}_{Pmax} - {μ}_{Pmin} + {ξ}_{{P}_{SB}} ( {V}_{SB} ) + {\overline{ξ}}_{{P}_{SB}} = 0 & ( 121 ) \\ {b}_{Q} + 2 {c}_{Q} {Q}_{SB} + \frac{1}{{V}_{SB}^{k}} {λ}_{Vsb} + {μ}_{Qmax} - {μ}_{Qmin} + {ξ}_{{Q}_{SB}} ( {V}_{SB} ) + {\overline{ξ}}_{{Q}_{SB}} = 0 & ( 122 )\end{matrix}$$

wherein μ_{Pmax}, μ_{Pmin}, μ_{Qmax}, μ_{Qmin}, μ_{Vmax} and μ_{Vmin} are Lagrange multipliers related to the limits of real, reactive power and slack bus voltage respectively, and λ_{Vsb} and λ_{V0} are Lagrange multipliers related to the slack bus voltage and ground reference. Lastly, ξ_{SB} (V_{SB}, I_{SB}^{R}, I_{SB}^{I}), ξ_{P}_{_{SB}} (V_{SB}) and ξ_{Q}_{_{SB}} (V_{SB}) together with ξ̅_{SB}, ξ̅_{P}_{_{SB}} and ξ̅_{Q}_{_{SB}} represent the second order sensitivities related to the slack bus and their corresponding historic terms.

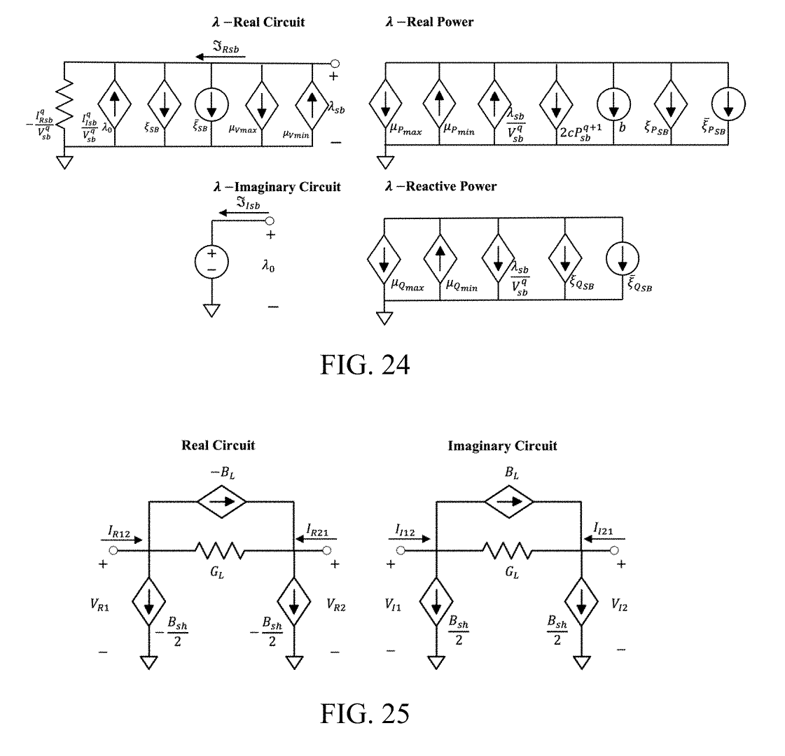

As can be seen from Equation (120), the term wherein the real Lagrange current, i.e. ℑ_{Rsb}, is proportional to the Lagrange multipliers related to the slack bus voltages and can be represented with a conductance. The second term proportional to the Lagrange multipliers related voltages of the other circuit is represented by voltage controlled current source. In addition, the terms wherein the ℑ_{Rsb} is proportional to the Lagrange multipliers related to limits of slack bus voltage can be represented by controlled current sources. On the other side, Equations (121) and (122) represent the additional constraints added for real and reactive power of the slack bus generator, hence are appended to the circuit equations. The complete equivalent split circuit of Equation (120) that further models ∇_{λ} [symbol] part of KKT conditions, i.e., Equation (89), is shown in FIG. 24. It should be noted that the second order sensitivities from (120)-(122) correspond to the controlled sources, while the respective historic terms are mapped to the constant sources.

II. J. vii Transmission Line with Thermal Limit

The governing split-circuit equations of a transmission line are given as:

$$\begin{matrix}{I}_{R 12} = - \frac{{B}_{sh}}{2} {V}_{I 1} + {G}_{L} ( {V}_{R 1} - {V}_{R 2} ) - {B}_{L} ( {V}_{I 1} - {V}_{I 2} ) & ( 123 ) \\ {I}_{I 12} = \frac{{B}_{sh}}{2} {V}_{R 1} + {G}_{L} ( {V}_{I 1} - {V}_{I 2} ) + {B}_{L} ( {V}_{R 1} - {V}_{R 2} ) & ( 124 ) \\ {I}_{R 21} = - \frac{{B}_{sh}}{2} {V}_{I 2} + {G}_{L} ( {V}_{R 2} - {V}_{R 1} ) - {B}_{L} ( {V}_{I 2} - {V}_{I 1} ) & ( 125 ) \\ {I}_{I 21} = \frac{{B}_{sh}}{2} {V}_{R 2} + {G}_{L} ( {V}_{I 2} - {V}_{I 1} ) + {B}_{L} ( {V}_{R 2} - {V}_{R 1} ) & ( 126 )\end{matrix}$$

wherein Bₛₕ, B_{L} and G_{L} are pi-model transmission line parameters, i.e. shunt and series susceptance and series conductance respectively, V_{R1}, V_{I1}, V_{R2} and V_{I2} are the real and imaginary voltages across the transmission line and I_{R12}, I_{I12}, I_{R21} and I_{I21} are the currents flowing between bus 1 and bus 2.

As can be seen from Equations (123) to (126), the term wherein the real currents are proportional to the bus voltage of the other circuit can be represented by a voltage controlled current source. Also, the terms wherein the current is proportional to the voltage drop across them can be represented by a conductance, while the terms proportional to the voltage drop of other circuit can be represented by a current controlled current source. The equivalent split circuit of a transmission line that further models ∇_{λ} [symbol] part of KKT conditions, i.e., Equation (89), is shown in FIG. 25.

To derive a transmission line equivalent the that satisfies the KKT conditions given by Equation (88) and has the thermal, i.e. current limits incorporated, the Lagrangian function from Equation (87) is differentiated with respect to the state and control variables of a transmission line. Governing equations obtained in terms of Lagrange multipliers are then given as:

$$\begin{matrix}{R 12}_{} = \frac{{B}_{sh}}{2} {λ}_{I 1} + {G}_{L} ( {λ}_{R 1} - {λ}_{R 2} ) + {B}_{L} ( {V}_{I 1} - {V}_{I 2} ) + {π}_{R 1} {μ}_{Imax} + {ξ}_{R 12} ( {I}_{R} , {I}_{I} ) + {\overline{ξ}}_{R 12} & ( 127 ) \\ {I 12}_{} = - \frac{{B}_{sh}}{2} {λ}_{R 1} + {G}_{L} ( {λ}_{I 1} - {λ}_{I 2} ) - {B}_{L} ( {λ}_{R 1} - {λ}_{R 2} ) + {π}_{I 1} {μ}_{Imax} + {ξ}_{I 12} ( {I}_{R} , {I}_{I} ) + {\overline{ξ}}_{I 12} & ( 128 ) \\ {R 21}_{} = \frac{{B}_{sh}}{2} {λ}_{I 2} + {G}_{L} ( {λ}_{R 2} - {λ}_{R 1} ) + {B}_{L} ( {λ}_{I 2} - {λ}_{I 1} ) + {π}_{R 2} {μ}_{Imax} + {ξ}_{R 21} ( {I}_{R} , {I}_{I} ) + {\overline{ξ}}_{R 21} & ( 129 ) \\ {I 21}_{} = - \frac{{B}_{sh}}{2} {λ}_{R 2} + {G}_{L} ( {λ}_{I 2} - {λ}_{I 1} ) - {B}_{L} ( {λ}_{R 2} - {λ}_{R 1} ) + {π}_{I 2} {μ}_{Imax} + {ξ}_{I 21} ( {I}_{R} , {I}_{I} ) + {\overline{ξ}}_{I 21} & ( 130 )\end{matrix}$$

wherein λ_{R1}, λ_{R2}, λ_{I1} and λ_{I2} are Lagrange multipliers related to the real and imaginary bus voltages, μ_{Imax} Lagrange multiple related to the thermal limit, i.e. current magnitude in the series element, ξ_{R12}(I_{R}, I_{I}), ξ_{I12} (I_{R}, I_{I}), ξ_{R21}(I_{R}, I_{I}) and ξ_{I21}(I_{R}, I_{I}), represent the second order sensitivities related to the transmission line thermal constraint, while π_{R1}, π_{R2}, π_{I1} and π_{I2} are placeholder constants in terms of the real and imaginary currents flowing through the series element of the transmission line given as:

π_{R1}=2G_{L}I_{R}^{k}+2B_{L}I_{I}^{k} (131)

π_{I1}=−2B_{L}I_{R}^{k}+2G_{L}I_{I}^{k} (132)

π_{R2}=−2G_{L}I_{R}^{k}−2B_{L}I_{I}^{k} (133)

π_{I2}=2B_{L}I_{R}^{k}−2G_{L}I_{I}^{k} (134)

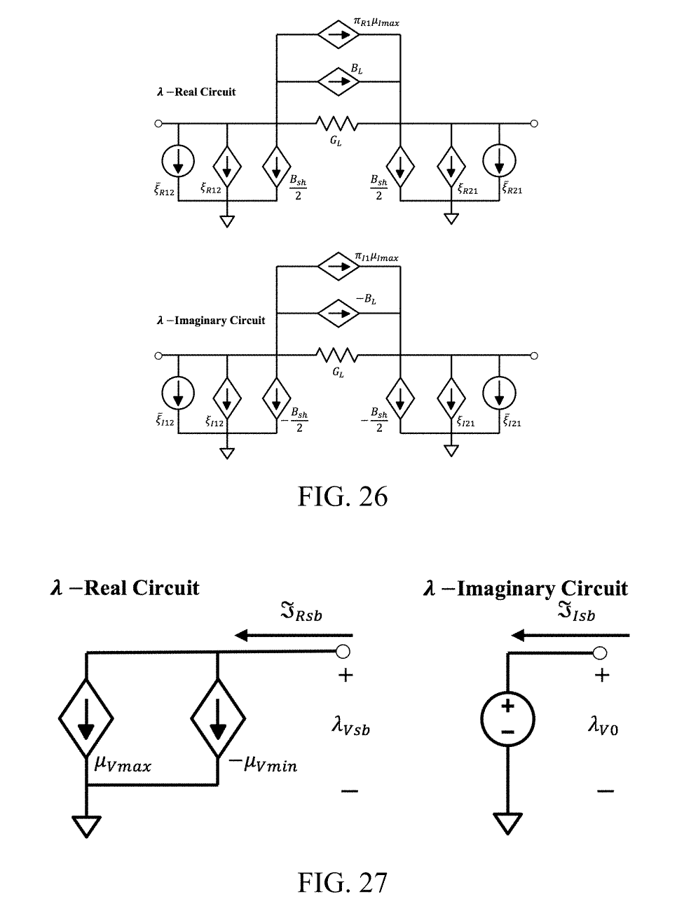

As can be seen from Equations (127) to (130), the terms wherein the real currents are proportional to the Lagrange multiplier related to bus voltage of the other circuit can be represented by a voltage controlled current source. Also, the terms wherein the current is proportional to the difference of Lagrange multipliers related to the bus voltages across them are represented by a conductance, while the terms proportional to the difference of Lagrange multipliers related to the bus voltages of other circuit are represented by a current controlled current source. Lastly, the second order sensitivity terms together with the corresponding historic terms are represented by controlled and constant current sources respectively. The equivalent split circuit of a transmission line that further models ∇_{λ} [symbol] part of KKT conditions is shown in FIG. 26.

### II. K Nonlinear GB-Optimal Power Flow (AC-GB-OPF)

As discussed in the algorithm section, GB-OPF is based on simplification of generation real and reactive power constraints, wherein the real and reactive power state variables are converted to the equivalent conductance and susceptance variables at a fixed voltage magnitude. It is important to note that the voltage magnitude at a bus is not fixed and it still remains the control variable within the GB-OPF framework. Hence, only PV generator bus, voltage magnitude constraint, and slack generator models will be changed. Moreover, all the previously derived equivalent split-circuits for transmission line with thermal limit, PQ and BIG load models, as well as variable shunts element will remain the same as in Full-OPF.

### II. K. i PV Generator Bus (GB)

The PV generator bus defined in the Full-OPF section is modified such that the real and reactive power state variables are transformed to the equivalent conductance and susceptance state variables at the fixed value of voltage magnitude. Since the voltage magnitude at the generator bus is not assumed to be fixed within the GB-OPF framework, Equations (94) and (95) become redundant and hence, can be removed. Moreover, since limiting the real and reactive power of a PV generator becomes equivalent to the limiting of conductance and susceptance, the equations from Equation (98) and (99) are replaced by the new constraints derived from the ∇_{λ} [symbol] KKT conditions that are further given as:

b_{P}d_{sq}^{k}+2c_{P}|d_{sq}^{k}|²G_{G}−V_{RG}^{k}λ^{RG}−V_{IG}^{k}λ_{IG}+d_{sq}^{k}(μ_{Pmax}−μ_{Pmin})+ξ_{P}+ξ̅_{P}=0 (135)

b_{Q}d_{sq}^{k}+2c_{Q}|d_{sq}^{k}|²B_{G}−V_{IG}^{k}λ_{RG}+V_{RG}^{k}λ_{IG}+d_{sq}^{k}(μ_{Qmax}−μ_{Qmin})+ξ_{Q}+ξ̅_{Q}=0 (136)

Lastly, the complete set of governing equations of a PV generator bus in GB-OPF is defined by Equations (92), (93), (96), (97), (135), and (136).

### II. K. ii Voltage Magnitude Constraint (GB)

The equivalent circuit of a voltage magnitude constraint derived in the Full-OPF section that further satisfies the ∇_{λ} [symbol] KKT conditions is shown to be dependent on the number of the generators and PQ loads connected to the respective bus. It can be shown that this dependency is related to the number of additional constraints added to define the relationship between the newly introduced conductance and susceptance state variables of a generator and the respective real and reactive powers. Since, the power related constraints given by Equations (94) and (95) become redundant in GB-OPF formulation, the parameters of ∇_{λ} [symbol] equivalent circuit defined in Equations (112) and (113) will be replaced by the ones defined as:

$$\begin{matrix}{γ}_{R}^{k} = - \frac{{( {I}_{PQ}^{R} )}^{k}}{{d}_{sq}^{k}} & ( 137 ) \\ {γ}_{I}^{k} = - \frac{{( {I}_{PQ}^{I} )}^{k}}{{d}_{sq}^{k}} & ( 138 )\end{matrix}$$

In addition, the complete set of governing equations that describe the voltage magnitude constraint within the GB-OPF framework is defined by Equations (108) to (111), (137), and (138).

### II. K. iii Slack Generator Bus (GB)

The slack bus real and reactive powers are defined as functions of bus voltage and real and reactive currents respectively, i.e. Equations (26) to (30). To transform the slack bus generator to the GB-OPF framework, the respective real and reactive power constraints are converted to the equivalent real and reactive current ones. Hence, the governing equation of the equivalent split circuit for a slack bus generator (FIG. 27) that further models the ∇_{λ} [symbol] part of KKT conditions can be defined as:

ℑ_{Rsb}=|μ_{Vmax}−μ_{Vmin} (139)

b_{P}V_{SB}^{k}+2c_{P}(V_{SB}^{k})²(I_{SB}^{R})^{k+1}+λ_{Vsb}+V_{SB}^{k}(μ_{Pmax}−μ_{Pmin})+ξ_{Psb}+ξ̅_{Psb}=0 (140)

−b_{Q}V_{SB}^{k}B+2c_{Q}(V_{SB}^{k})²(I_{SB}^{I})^{k+1}+λ_{V0}+V_{SB}^{k}(μ_{Qmin}−μ_{Qmax})+ξ_{Qsb}+ξ̅_{Qsb}=0 (141)

### II. L Solving for Global Operating Point of an AC-OPF Circuit Using A-Stepping Homotopy Method

In the previous section, is was shown how the complete AC-OPF problem can be reformulated in terms of equivalent circuit models. Therefore, decades of advanced research in the field of circuit simulations can be applied directly to the AC-OPF problem and further provide the ability to analyze the complete problem from entirely new perspective. As has been shown elsewhere, the equivalent split-circuit formulation allows for the derivation of new continuation and homotopy methods to robustly simulate the large-scale cases solely dependent on the physics-based formulation of powerflow problem. More importantly, the convergence to the high voltage solution of the powerflow problem can be guaranteed for any initial starting condition.

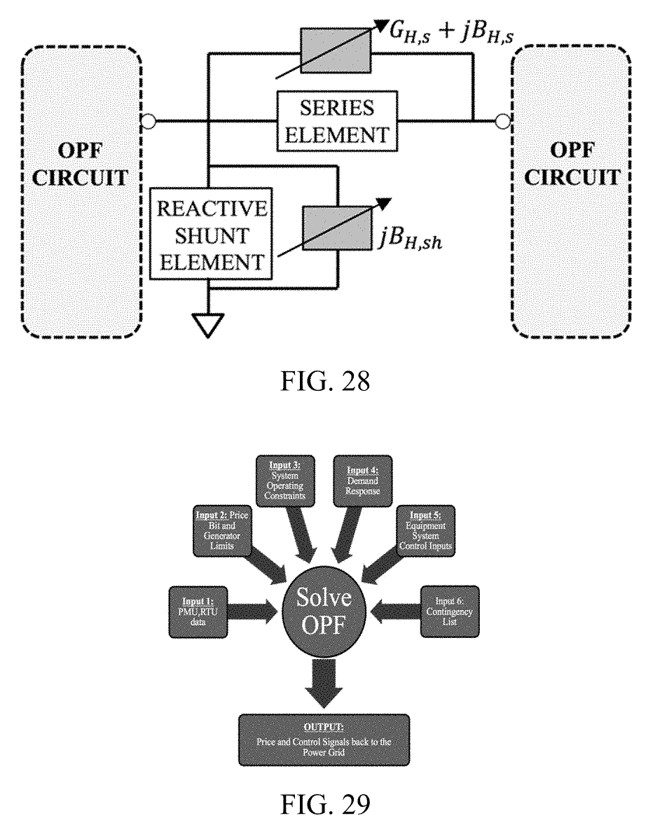

This disclosure introduced the Admittance stepping (A-stepping) homotopy method, which is based on reduction and expansion of the equivalent OPF circuit. The original nonlinear AC-OPF equivalent circuit is firstly converted to an equivalent circuit, whose operating point represent the solution of the economic dispatch problem. Referring to FIG. 28 for a visualization, this is achieved by shorting every series circuit element, i.e., connecting large admittance in parallel with an element, and opening all reactive shunt elements of the complete equivalent circuit, i.e., connecting conjugate susceptance in parallel with the element. The solution of the original AC-OPF problem is then obtained in two steps. In the first step, all of the added series admittances are gradually decreased to zero while resolving for the operating point of the AC-OPF equivalent circuit and keeping the reactive power sources off. Afterwards, the second step turns on the shunt reactive sources by gradually relaxing the impedance added in series with the shunt elements. The next three subsections thoroughly describe both steps of the introduced A-stepping homotopy method, as well as provide the proof of convergence to the global solution of the AC-OPF problem for the proposed algorithm.

II. L. i. Contracting the AC-OPF Equivalent Split-Circuit

The series element of a AC-OPF equivalent circuit is shorted by adding the very large admittance in parallel with the respective series element. Most importantly, in order to fully preserve the characteristics of the equivalent circuit, the conductance/susceptance (GB) ratio of a series homotopy admittance (Y_{H,s}=G_{H,s}+jB_{H,s}) related to admittance of the series element needs to be such that the GB ratio of a total admittance remains the same. Hence, the value of the series homotopy admittance can be obtained as:

Y_{H,s}=ζY_{ik,s} (142)

wherein Y_{ik,s} is the admittance of the series element connecting buses i and k, and ζ is a homotopy constant, set such that |Y_{H,s}|>>|Y_{ik,s}|.

The shunt reactive elements, i.e., capacitors, Q loads, etc., of AC-OPF equivalent circuit are set to zero by connecting the conjugate reactance in parallel with the original shunt reactive element. For instance, the homotopy shunt susceptance of a shunt capacitor (B_{i,sh}) connected to bus i is given as:

B_{H,sh}=−B_{i,sh} (143)

In addition, an operating point of the fully contracted AC-OPF circuit represents the solution equivalent to the economic dispatch problem, which is independent of voltage magnitude. Thus, without loss of generality the voltage magnitude can be set to its maximum limit, such that the series line losses in the first homotopy step are minimized, i.e. constant real power load models will draw the “lowest” current and “highest” voltage.

II. L. ii. Expanding the AC-OPF Equivalent Split-Circuit

Once the complete AC-OPF is fully contracted, it will be expanded by solving for the operating point of the original circuit in two steps. In the first step, the values of the series homotopy admittances are gradually decreased to zero, while keeping the reactive shunt homotopy admittance on. It should be noted that for each decrement of the series homotopy admittance, the operating point of the AC-OPF circuit is obtained and used as an initial starting point for solving the circuit for the next decrement. Hence. the gradual decreasing of the series homotopy admittance can be written in terms of total series admittance between buses i and k (Yᵢₖ) as:

Yᵢₖ=Y_{ik,s}+(1−ξ)Y_{H,s} (144)

wherein ξ is a homotopy decrement constant, i.e. ξϵ[0,1]. It is noted that the homotopy decrement constant can be dynamically scaled up by the procedure similar to the dynamic time stepping in the transient circuit simulation.

After the series homotopy admittances are completely turned off, the second step of the AC-OPF circuit expansion is started by gradually decreasing the homotopy shunt susceptance. For the example of a shunt capacitor, this can be further defined in terms of the total shunt susceptance at bus i as:

Bᵢ=B_{i,sh}+(1−ξ)B_{H,sh} (145)

Importantly, as it can be seen from the introduced A-stepping homotopy method, the homotopy relaxation is solely based on adding the homotopy admittances that are linear elements in the equivalent split-circuit formulation. Hence, the proof of convergence to the global AC-OPF solution obtained by contracting and expanding the AC-OPF equivalent circuit is given in next subsection.
II. L. iii. Convergence to the Global AC-OPF Solution

Assumption 1. If the operating point of the completely contracted AC-OPF equivalent split-circuit represents the global solution of the Economic Dispatch problem, assume that the global solution of the AC-OPF bounded by the additional linear network constraints exist within the same connected set.

Lemma 1. Let G: D⊆ [symbol] ⁿ→D be a nonlinear mapping which has a fixed point X* that represents the global operating point of the AC-OPF equivalent circuit.

X*=G(X*) (146)

If X*a global operating point of the circuit exists, there also exists an open ball of attraction with radius r≠0, Bᵣ(X*, r):

Bᵣ(X*,r)={Xϵ [symbol] ⁿ:∥X−X*∥<r}⊆D (147)

such that for any initial approximation X₀ϵBᵣ the successive linear approximations:

Xₖ₊₁=G(Xₖ),∀kϵ[0,N] (148)

represents a Cauchy sequence, i.e. remains in D and converges to X*in finite number of iterations (N).

Lemma 2. Let X₀* and X₁* be global operating points of the economic dispatch problem and the AC-OPF equivalent circuit after the first homotopy relaxation step respectively. According to Assumption 1 and Lemma 1, if both solution exist, there has to exist a change in the homotopy admittance, δ_{Y}≠0 that further constraints the solution space such that the global solution of economic dispatch problem stays in the open ball of attraction of the first homotopy relaxation equivalent circuit:

Bᵣ₁(X₁*,r)={X₀*ϵ [symbol] ⁿ:∥X₀*−X₁*∥<r₁}⊆D (149)

Theorem 2. Let Xₘ* and Xₘ₊₁* be the global operating points of the AC-OPF equivalent circuit at m^{th} and (m+1)^{th} homotopy steps. Furthermore, let Xₘ* be a known global operating point obtain from previous m−1 steps. As a generalization of Lemma 2, if the Xₘ₊₁* solution exists, there has to exist a nonzero δ_{Y} to shifts the linear network constraints such that the known Xₘ* remains in the ball of attraction Bᵣ(Xₘ₊₁*,r).

Proof. According to Ohm's Law, the current is directly proportional to the voltage across the admittance and its sensitivity to voltage is defined by the value of admittance. Thus, the homotopy step introduces the change in network admittance that will further shift the operating point of the contracted equivalent circuit as a function of the change in homotopy admittance. Hence, there has to exist a change of admittance such that the previous operating point of the circuit remains in the Banach space of the new optimal solution. Lastly, from the linear relationship between network constraints in equivalent circuit formulation and by considering the Assumption 1, it can be deduced without loss of generality that if the global operating points for both economic dispatch and AC-OPF equivalent circuit exist, there has to exist a finite number of homotopy steps that will ensure that each of the homotopy steps following the global operating point of Economic Dispatch problem remains in the Basin of attraction of the new operating point.

### III. Example Methods and Implementations

### III. A Example Inputs and Output of an OPF Method

This subsection describes example algorithms that can be used to determine an OPF solution. A diagram illustrating example inputs and outputs for each of these algorithms is given in FIG. 29. As can be seen in FIG. 29, there can be six major classes of inputs, i.e., Input 1 through Input 6) to an OPF solver. The input from the first class (Input 1) uses the measurements data from phasor-measurements units (PMUs) as well as remote terminal units (RTUs) for further generation of accurate load models. On the other side, inputs from the second through fifth classes (Inputs 2 to 5) in FIG. 29 are used to generate the system constraints and the objective function that is to be minimized, while the sixth class (Input 6) represents an optional contingency list that is to be applied for the SCOPF (again, security constraint optimal power flow).

### III. B Example Method Combining Direct OPF Solution and Iterative GB-OPF Solution

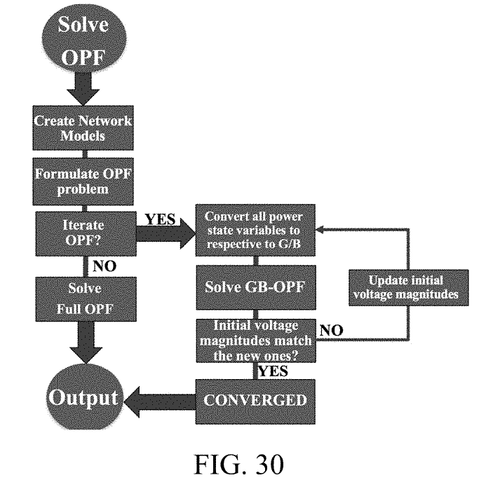

An example OPF method, illustrated in FIG. 30, is able to solve for an OPF directly (left-hand side of FIG. 30) as a full problem without any simplification, as well as iteratively (GB-OPF) (right-hand side of FIG. 30), wherein the power generation cost function and generation power state variables are converted to respective conductance and susceptance state variables at a fixed voltage magnitude. The latter problem may then be iteratively solved until the voltage magnitude convergence.

It is noted that both full and iterative OBF algorithms can use the McCormick convex relaxation and are based on solving the relaxed problem to obtain the initial guess and lower optimal bound for the original problem. Furthermore, the upper optimal bound of the power flow is obtained by solving the original nonlinear problem. Thus, the iterations between relaxed and the original problem tightens the bounds of the relaxed problem until the convergence the global optimum is reached, i.e., lower optimal bound becomes equal to the upper one. Details for two of the aforementioned OPF algorithms are further described in the following sections.

### III. C. i Example Full Optimal Power Flow (Full-OPF) Method

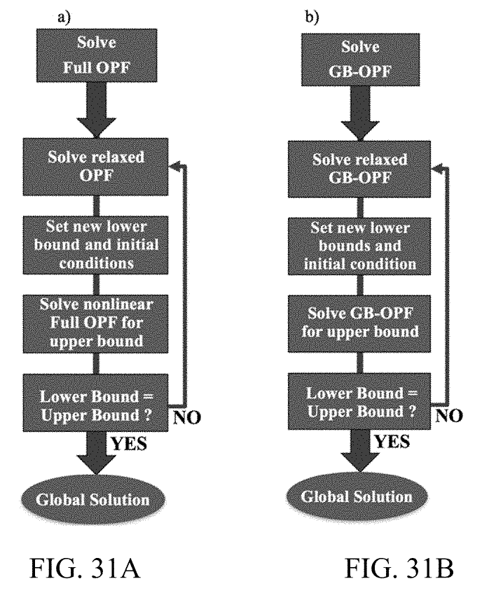

It was shown above that an OPF problem could be translated to the equivalent circuit domain without loss of generality. One method to handle the bilinear nonlinearities introduced in the optimization program and further obtain the global solution is based on consecutively solving the relaxed convex problem and the original nonlinear optimal power flow problem. An example flow chart of a Full-OPF algorithm is shown in FIG. 31A. As can be seen in FIG. 31A, the output of the solved relaxed problem, which also represents the lower optimal bound of the optimal power flow, is used as an initial starting point for the nonlinear OPF problem. More importantly, the solution of the original nonlinear OPF represents the upper bound of the optimal solution. It is important to note that each consecutive solving of relaxed and the original nonlinear problem tightens the bounds around the global optimal solution that finally converges to a one unique global optimal solution, i.e., the lower and upper bounds converge to same point. At the end, the output of the method is a solution that will guarantee the optimal system operation for the given demand response and will be applied back to the power grid.

### III. C. ii Example Iterative Optimal Power Flow (GB-OPF) Method

In order to decrease the complexity of the optimization program introduced by the additional bilinear nonlinearities and accurately handle the traditionally postulated power based constraints and models, an iterative optimal power flow algorithm is introduced. Contrary to the Full-OPF, in the iterative OPF the generated real and reactive power state variables are converted to the respective conductance and susceptance variables at a nominal voltage. The resulting optimization problem, together with linear BIG load models, doesn't contain the bilinear nonlinearities and further decreases the complexity of the optimization program. An example simplified GB-OPF method is shown in FIG. 31B. As can be seen in FIG. 31B, the method resembles the method for Full-OPF (FIG. 31A), with a difference that the less-nonlinear program is solved. Moreover, the global solution of the voltage magnitudes obtained from the GB-OPF is tested for a match with the voltage used in conversion of the power state variables (FIG. 30). If the new voltage magnitudes don't match with the voltage magnitudes used in conversion, the respective constraints are updated with a new voltage and the GB-OPF is solved until convergence. It is noted that the introduced GB-OPF represents a good approximation to the original problem, hence could be solved only once if the faster algorithm is desired.

### III. D Example Method Combining Nonlinear Direct AC-OPF Solution and Iterative AC-GB-OPF Solution

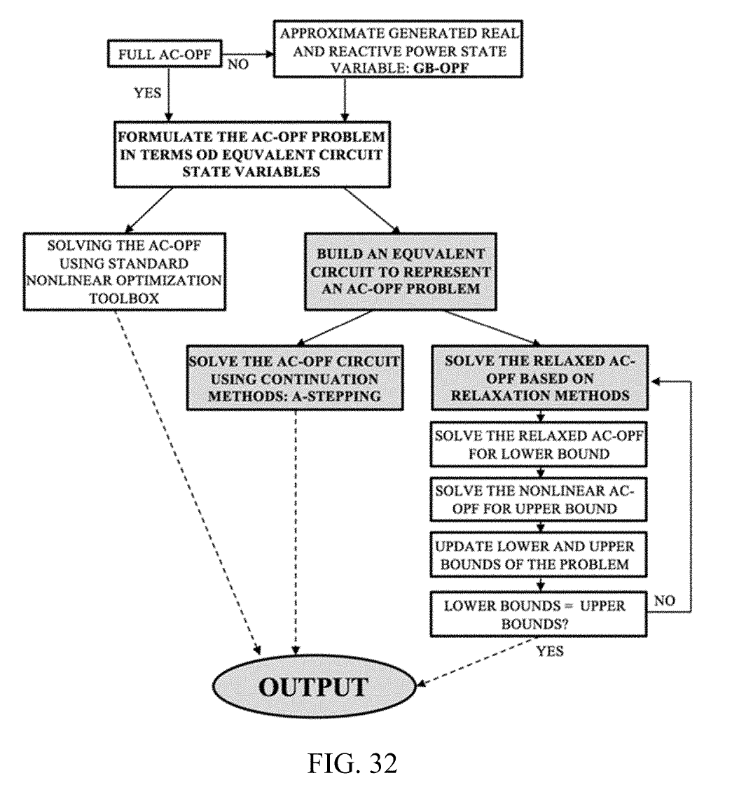

FIG. 32 illustrates an example method of obtaining an OPF solution using either a direct AC-OPF formulation or an iterative AC-GB-OPF formulation. The method of FIG. 32 is generally similar to the method of FIG. 30 in the manner of the direct and iterative solution options. However, differences include the fact that the method of FIG. 32 is for nonlinear OPF formulations and the option of using A-stepping homotopy to solve the AC-GB-OPF problem of the iterative OPF option.

### III. E Example Implementation of an OPF Solver in a Power Grid Network

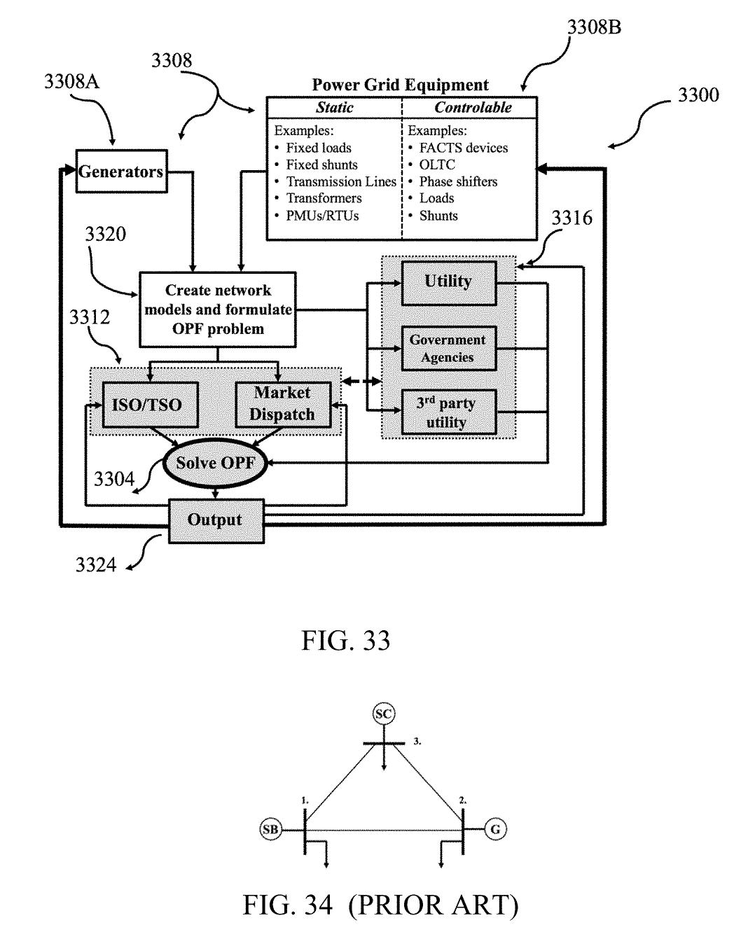

FIG. 33 illustrates an example scenario 3300 in which an OPF solver 3304, made in accordance with aspects of the present invention, is used to solve for an OPF solution for a power supply system 3308 that includes a plurality of generators (shown collectively at element 3308A) and power grid equipment (shown collectively at element 3308B). Power supply system 3308 may be any relevant power supply system, such as a public utility grid, a private utility grid, a combination thereof, or a portion of any of these possibilities, among others. Depending on the character and nature of power supply system 3308, the power supply system may be controlled by one or more system operator 3312, such as a transmission system operator (TSO), an ISO, and/or a market dispatch, among others. Also depending on the character and nature of power supply system 3308, the power supply system may be monitored and/or regulated by one or more monitoring/regulating entities 3316, such one or more public utility companies, one or more governmental agencies, and/or one or more 3^{rd} party utility companies, among others.

At block 3320, network models are created and the OPF problem to be solved by OPF solver 3304 is formulated. The OPF problem may be formulated according to any one or more of the formulation techniques described above including, but not limited to, a Full-OPF formulation, a GB-OPF formulation, an AC-OPF formulation, an SCOPF formulation, and an AC-GB-OPF formulation, among others, as described and illustrated herein in detail. Correspondingly, OPF solver 3304 may solve the OPF problem using any one or more of the techniques described herein, including, but not limited to, a direct technique, an iterative technique, the A-stepping homotopy technique, relaxation techniques, and nonlinear optimization techniques, among others. Inputs for the network models and OPF problem can include, but not be limited to, the outputs of generators 3308A and outputs from various pieces of power grid equipment 3308B and/or sensors associated therewith. The created network models and OPF problem may be provided to any one or more of system operators 3312 and/or to any one or more of monitoring/regulating entities 3316, if present, which may provide any suitable information to OPF solver 3304 for determining an appropriate solution to the OPF problem formulated at block 3320.

Output 3324 of OPF solver 3304 may include signals based on the solution determined by the OPF solver solving the OPF problem. Such signals can include suitable control signals for controlling generators 3308A and/or for controlling controllable pieces of power grid equipment 3308B. Those skilled in the art will readily understand the type, nature, and character of such control signals given a desired application of OPF solver 3304. Other output of OPF solver 3304 may include information in addition to or in lieu of control signals for allowing any one or more of each of system operators 3312 and/or monitoring/regulating entities 3316 to keep up to date on the status of power grid 3308 and/or to perform the corresponding function(s). Those skilled in the art will readily appreciate that scenario 3300 is provided for the sake of illustrating and is not intended to limit the scope of applicability of aspects of the present invention in any manner. Indeed, those skilled in the art will readily be able to adopt and adapt various aspects of the present invention to many scenarios that are variation of scenario 3300 or completely different from scenario 3300.

### IV Simulation Results

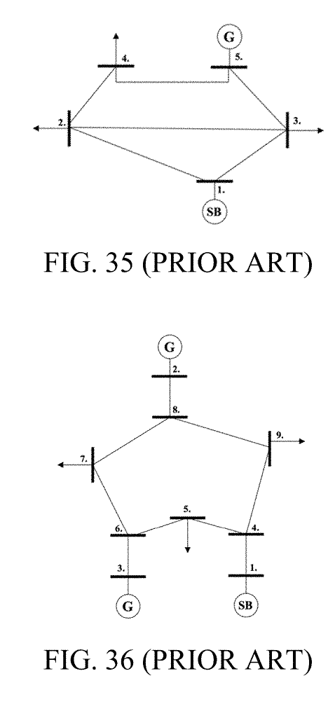

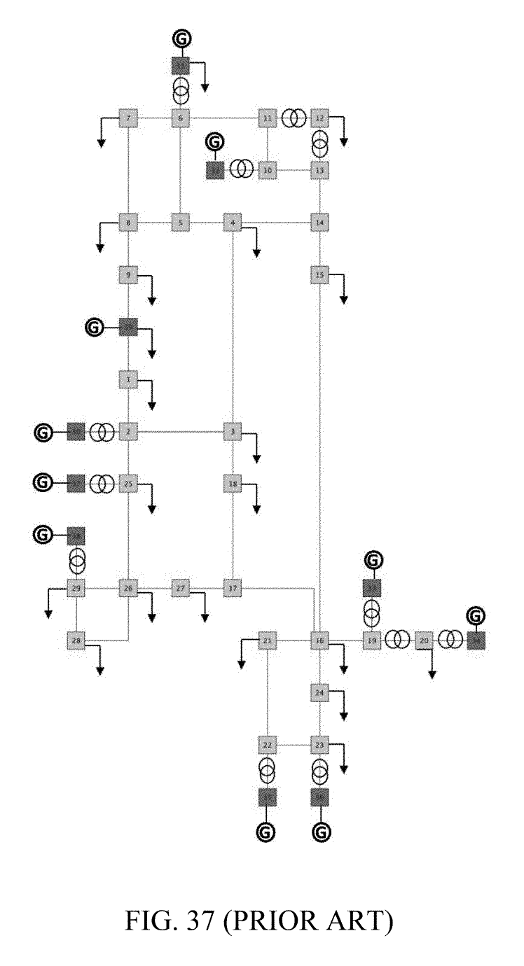

The example methods describe above were applied to three known benchmarks (3-, 5-, and 9-bus cases) in the literature that are considered to have multiple optima solutions. The 3-, 5-, and 9-bus test cases are shown in FIGS. 34-36, respectively. The corresponding OPF problem for each was formulated using the equivalent circuit formulation, and it was shown that the iterative OPF converges after one iteration. The results for the 3- and 5-bus test cases from an optimization program based on the proposed equivalent circuit method are shown to agree with the optimal power flow results from the commercial MATPOWER tool, as shown in Tables 1-4 (3-bus test case (see FIG. 34)) and Tables 5-8 (5-bus test case (see FIG. 35)), below. Tables 8-12, below, show the results for the optimal solutions obtained for the 9-bus test case (FIG. 36). The solution obtained from the equivalent circuit based optimization program are superior to those obtained by MATPOWER, and the results match the “best optimal solution” known based on exhaustive exploration, as described in the literature. In addition, the example methods described above were also applied to a 39-bus test case known to have 16 local solution within the operating range, hence making it challenging example for the commercial solvers. A diagram of a 39-bus test case is presented in FIG. 37. The summary and comparison between simulated results of all test cases is given in Table 13, while the simulation results of 39-bus test case and the comparison between the full AC-OPF and GB-OPF results are given in Tables 14-15 respectively.

TABLE 1
Comparison of Generated and Distributed Powers in
p.u. for 3 bus test case

| | Current method | | | | MATPOWER | | | |
|---|---|---|---|---|---|---|---|---|
| Bus # | P_{G} | Q_{G} | P_{L} | Q_{L} | P_{G} | Q_{G} | P_{L} | Q_{L} |
| 1 | 1.284 | −0.179 | 1.10 | 0.4 | 1.284 | −0.179 | 1.10 | 0.4 |
| 2 | 1.882 | 0.037 | 1.10 | 0.4 | 1.882 | 0.037 | 1.10 | 0.4 |
| 3 | 0 | 0.007 | 0.95 | 0.5 | 0 | 0.007 | 0.95 | 0.5 |

TABLE 2
Cost Function Comparisons (3 bus test case)

| Formulation | Minimized cost value | Total real power generated |
|---|---|---|
| Current method | $5,694.54 | 316.68 MW |
| MATPOWER | $5,694.54 | 316.68 MW |

TABLE 3
Voltage Magnitude/Angles Comparison
(3 bus test case)

| | |
|---|---|
| Current method | MATPOWER |

| | Voltage | Voltage | Voltage | Voltage |
|---|---|---|---|---|
| Bus # | Magnitude | Angle (°) | Magnitude | Angle (°) |
| 1 | 1.10 | 0 | 1.10 | 0 |
| 2 | 1.10 | 9.0 | 1.10 | 9.0 |
| 3 | 1.10 | −11.6 | 1.10 | −11.6 |

TABLE 4
Comparison of Real Power Losses in Transmission Lines
(3 bus)

| From | To | | |
|---|---|---|---|
| Bus | Bus | Current method | MATPOWER |
| 1 | 2 | 0.15 | 0.15 |
| 1 | 3 | 0.83 | 0.83 |
| 2 | 3 | 0.69 | 0.69 |

| | | |
|---|---|---|
| TOTAL | 1.67 MW | 1.67 MW |

TABLE 5
Comparison of Generated and Distributed Powers in
p.u. for 5 bus test case

| | Current method | | | | MATPOWER | | | |
|---|---|---|---|---|---|---|---|---|
| Bus # | P_{G} | Q_{G} | P_{L} | Q_{L} | P_{G} | Q_{G} | P_{L} | Q_{L} |
| 1 | 1.79 | 0.95 | 0 | 0 | 1.79 | 0.95 | 0 | 0 |
| 2 | 0 | 0 | 1.3 | 0.2 | 0 | 0 | 1.3 | 0.2 |
| 3 | 0 | 0 | 1.3 | 0.2 | 0 | 0 | 1.3 | 0.2 |
| 4 | 0 | 0 | 0.65 | 0.1 | 0 | 0 | 0.65 | 0.1 |
| 5 | 2.05 | −0.42 | 0 | 0 | 2.05 | −0.42 | 0 | 0 |

TABLE 6
Cost Function Comparisons (5 bus test case)

| Formulation | Minimized cost value | Total real power generated |
|---|---|---|
| Current method | $1,482.22 | 384.00 MW |
| MATPOWER | $1,482.22 | 384.00 MW |

TABLE 7
Voltage Magnitude/Angles Comparison
(5 bus test case)

| | |
|---|---|
| Current method | MATPOWER |

| | Voltage | Voltage | Voltage | Voltage |
|---|---|---|---|---|
| Bus # | Magnitude | Angle (°) | Magnitude | Angle (°) |
| 1 | 1.07 | 0 | 1.07 | 0 |
| 2 | 0.99 | −3.5 | 0.99 | −3.5 |
| 3 | 0.99 | −3.3 | 0.99 | −3.3 |
| 4 | 1.04 | 29.4 | 1.04 | 29.4 |
| 5 | 1.10 | 36.3 | 1.10 | 36.3 |

TABLE 8
Comparison of Real Power Losses in
Transmission Lines (5 bus)

| From | To | | |
|---|---|---|---|
| Bus | Bus | Current method | MATPOWER |
| 1 | 2 | 4.00 MW | 4.00 MW |
| 1 | 3 | 4.03 MW | 4.03 MW |
| 2 | 4 | 16.68 MW | 16.68 MW |
| 3 | 5 | 25.26 MW | 25.26 MW |
| 4 | 5 | 8.46 MW | 8.46 MW |
| 2 | 3 | 0.022 MW | 0.022 MW |

| | | |
|---|---|---|
| TOTAL | 58.5 MW | 58.5 MW |

TABLE 9
Comparison of Generated and Distributed Powers in p.u. for 9 bus test case

| | | | | | | | | | “Best Found” | | | |
|---|---|---|---|---|---|---|---|---|---|---|---|---|
| | Current method | | | | MATPOWER | | | | local optimum | | | |
| Bus # | P_{G} | Q_{G} | P_{L} | Q_{L} | P_{G} | Q_{G} | P_{L} | Q_{L} | P_{G} | Q_{G} | P_{L} | Q_{L} |
| 1 | 0.10 | −0.05 | 0 | 0 | 1.44 | −0.05 | 0 | 0 | 0.10 | −0.05 | 0 | 0 |
| 2 | 1.25 | −0.05 | 0 | 0 | 0.16 | −0.05 | 0 | 0 | 1.25 | −0.05 | 0 | 0 |
| 3 | 0.57 | −0.05 | 0 | 0 | 0.31 | −0.05 | 0 | 0 | 0.57 | −0.05 | 0 | 0 |
| 4 | 0 | 0 | 0 | 0 | 0 | 0 | 0 | 0 | 0 | 0 | 0 | 0 |
| 5 | 0 | 0 | 0.54 | 0.18 | 0 | 0 | 0.54 | 0.18 | 0 | 0 | 0.54 | 0.18 |
| 6 | 0 | 0 | 0 | 0 | 0 | 0 | 0 | 0 | 0 | 0 | 0 | 0 |
| 7 | 0 | 0 | 0.60 | 0.21 | 0 | 0 | 0.60 | 0.21 | 0 | 0 | 0.60 | 0.21 |
| 8 | 0 | 0 | 0 | 0 | 0 | 0 | 0 | 0 | 0 | 0 | 0 | 0 |
| 9 | 0 | 0 | 0.75 | 0.30 | 0 | 0 | 0.75 | 0.30 | 0 | 0 | 0.75 | 0.30 |

TABLE 10
Cost Function Comparisons (9 bus test case)

| | | Total real |
|---|---|---|
| Formulation | Minimized cost value | power generated |
| Current method | $3,087.00 | 192 MW |
| MATPOWER | $4,267.07 | 191 MW |
| “Best Found” local optimum | $3,087.00 | 192 MW |

TABLE 11
Voltage Magnitude/Angles Comparison (9 bus test case)

| | | | | | “Best Found” | |
|---|---|---|---|---|---|---|
| | | | MATPOWER | | local optimum | |
| | Current method | | | Voltage | | Voltage |
| | Voltage | Voltage | Voltage | Angle | Voltage | Angle |
| Bus # | Magnitude | Angle (°) | Magnitude | (°) | Magnitude | (°) |
| 1 | 0.91 | 0 | 0.90 | 0 | 0.91 | 0 |
| 2 | 0.92 | 12.3 | 0.92 | −11.2 | 0.92 | 12.3 |
| 3 | 0.94 | 7.0 | 0.93 | −9.4 | 0.94 | 7.0 |
| 4 | 0.91 | −0.4 | 0.91 | −5.8 | 0.91 | −0.4 |
| 5 | 0.92 | −0.7 | 0.91 | −9.7 | 0.92 | −0.7 |
| 6 | 0.94 | 4.8 | 0.93 | −10.6 | 0.94 | 4.8 |
| 7 | 0.93 | 4.5 | 0.92 | −13.0 | 0.93 | 4.5 |
| 8 | 0.93 | 7.1 | 0.92 | −11.9 | 0.93 | 7.1 |
| 9 | 0.90 | −0.6 | 0.90 | −10.7 | 0.90 | −0.6 |

TABLE 12
Comparison of Real Power Losses in Transmission Lines
(9 bus)

| From | To | | | “Best Found” |
|---|---|---|---|---|
| Bus | Bus | Current method | MATPOWER | local optimum |
| 1 | 4 | 0.00 MW | 0.00 MW | 0.00 MW |
| 4 | 5 | 0.01 MW | 0.76 MW | 0.01 MW |
| 5 | 6 | 1.12 MW | 0.07 MW | 1.13 MW |
| 3 | 6 | 0.00 MW | 0.00 MW | 0.00 MW |
| 6 | 7 | 0.03 MW | 0.19 MW | 0.03 MW |
| 7 | 8 | 0.28 MW | 0.06 MW | 0.29 MW |
| 8 | 2 | 0.00 MW | 0.00 MW | 0.00 MW |
| 8 | 9 | 1.90 MW | 0.09 MW | 1.90 MW |
| 9 | 4 | 0.02 MW | 0.85 MW | 0.02 MW |

| | | | |
|---|---|---|---|
| TOTAL | 3.36 MW | 2.02 MW | 3.40 MW |

TABLE 13
Summary and comparison of the AC-OPF results between the invention and the
existing state of art

| | # of local | | | | |
|---|---|---|---|---|---|
| | selections | | | | |
| Test Case | found* | Current Method | GB-OPF | MATPOWER | SDP |
| LMBM3 - 3 bus | 5 | Global Solution | Global Solution** | Global Solution | Global Solution |
| WB5mod - 5 bus | 4 | Global Solution | Global Solution** | Global Solution | Fails |
| Case9mod - 9 bus | 3 | Global Solution | Global Solution** | Global Solution | Fails |
| Case39mod2 - 39 bus | 16 | Global Solution | Global Solution** | Diverge | Fails |

**Global Solution of the GB approximated problem

TABLE 14
Cost function comparison (39-bus test case)

| | | Total real |
|---|---|---|
| Formulation | Minimized cost value | power generated |
| Equivalent circuit OPF | $941.7 | 3139 MW |
| GB-OPF | $950.5 | 3168 MW |
| “Best Found” local optimum | $941.7 | 3139 MW |

TABLE 15
Voltage magnitudes and angles comparison of 39-bus test case

| | Equivalent | | | | “Best Found” | |
|---|---|---|---|---|---|---|
| | circuit OPF | | | | local optimum | |
| | | Voltage | GB-OPF* | | | Voltage |
| | Voltage | Angle | Voltage | Voltage | Voltage | Angle |
| Bus # | Magnitude | (°) | Magnitude | Angle (°) | Magnitude | (°) |
| 30 | 1.041226 | 0.157 | 1.0500 | 0.0649 | 1.041226 | 0.157 |
| 31 | 0.950000 | 0 | 0.95 | 0 | 0.950000 | 0 |
| 32 | 0.995714 | −10.810 | 0.9961 | −13.2498 | 0.995714 | −10.810 |
| 33 | 0.950000 | −9.328 | 0.9500 | −3.9423 | 0.950000 | −9.328 |
| 34 | 0.950000 | −9.450 | 0.9500 | −6.9157 | 0.950000 | −9.450 |
| 35 | 0.950000 | −4.297 | 0.9707 | 3.0875 | 0.950000 | −4.297 |
| 36 | 0.995076 | −8.664 | 1.0500 | 13.9027 | 0.995076 | −8.664 |
| 37 | 1.019326 | −4.011 | 1.0500 | 20.9191 | 1.019326 | −4.011 |
| 38 | 0.966702 | −7.234 | 0.9562 | 0.3878 | 0.966702 | −7.234 |
| 39 | 1.019218 | 13.349 | 1.0398 | 9.4437 | 1.019218 | 13.349 |

*GB-OPF solution represents the solution of without iterations to match the full AC-OPF

V. Market Dispatch using Optimal Power Flow

An ultimate goal of ISO (Independent Service Operator) market software is the security-constrained, self-healing (corrective switching) AC optimal power flow with unit commitment over the optimal network. The potential savings assuming 5% increase in efficiency of market dispatch is equal to approximately 19 $billion/year for the United States grid operation. The methodologies set forth in this disclosure can result in achieving this goal. SCOPF (again, security constrained optimal power flow) as formulated in this disclosure can dispatch all the available generating units optimally in the spot-pricing market. Upon receiving price bids from the available generating units and their corresponding generation limits (Pₘₐₓ and Pₘᵢₙ), the ISOs and RTOs can run the SCOPF to dispatch the generators in most optimal manner. As a result, from the solution of the SCOPF the ISOs/RTOs will send out signals to the generating units to output their optimal power generation. From the solution of the SCOPF, the signals would also be generated for the control variables in the system. These control variables will be actuated by the system operator or the EMS software itself. Examples of these control variables include:
1. generator VARs within the plant;
2. taps or phase shifts of parallel transformers/generator step-up transformer (GSUs);
3. shunts (MVAR compensation) on the system buses; and
4. distributed slack MW power.

In addition to including the control variables in the formulation, the SCOPF can also formulate/limit the maximal allowed adjustments of the control variables between the base case and the post-contingency state.

The SCOPF will also ensure that none of the system equipment limits are violated. These limits include but are not limited to:
1. generator maximum and minimum active and reactive power;
2. transmission line current limits due to thermal overload or stability limit;
3. voltage magnitude of the system buses; and
4. shunt maximum and minimum susceptance/reactive power.
   The limits themselves can further be categorized and denoted by the short-term (emergency) limits, the medium-term limits, and the long-term (normal) operating limits.

In order, to dispatch the generating units economically, the objective function for the SCOPF would be to minimize the cost of generation. However, in order to be practically useful solution, the main objective function in the SCOPF must be augmented with additional functions for purposes such as:
1. including the optimization of controls for which clear costs cannot be determined;
2. discouraging controls or control targets from moving from their initial or scheduled values;
3. suppressing oscillations;
4. penalizing soft constraint violations; and
5. invoking priorities.

The methodology presented in this disclosure will be able to achieve all the postulated goals. Furthermore, the proposed formulation can be implemented in day-ahead operational planning by the ISOs that has become an exercise in managing uncertainty.

VI Power System Planning using Optimal Power Flow

The methodology disclose herein is flexible and can be used to address/analyze other goals for better operation of power system. In addition to optimally dispatching generators (economically), the disclosed methodology can also be used for power system planning. The formulation proposed in this disclosure can help analyze the most optimal reactive power scheduling, or perform voltage collapse analysis, or even congestion analysis. Some of the common objective functions to facilitate power system planning that can easily incorporated into formulations of the presently disclosed methodology are:
1. least-cost VAR installations;
2. least-number of control shifts;
3. minimize active power losses;
4. minimize reactive power losses;
5. minimize or maximize reactive power reserves;
6. minimize or maximize adjustable branch impedances; and
7. minimize or maximize adjustable bus shunts.

The proposed SCOPF would fit itself into a bigger system solution. The installations of PMUs and RTUs are resulting in bulk measurement data. This measurement data can be transferred into models using network modeling approach as described by equivalent circuit formulation. The network models can then be studied using the proposed optimal power flow formulation to compute required corrective actions. These corrective actions can then be implemented on the system equipment and the process can be repeated until optimal results are achieved.

### VII Security Constrained Optimal Power Flow (SCOPF)

In order for the optimal power flow to be used in a practical setting, it is critical that security of the grid is taken into account. Power system operators and planners often use the term “N−1” to describe the ability of the system to survive the loss of single equipment in the system. Similarly, the term “N−2” is used to describe the ability of the system to survive the simultaneous loss of two equipment in the system. In addition, another term “N−1-1” refers to one contingency, and then after initial response, a second contingency.

The notion of contingency is extremely important to best analyze the system. In a practical system, power system engineers study the vulnerabilities of their system and develop probability based contingency lists. A single contingency can be described a “system-event” that can involve anything from one to many simultaneous changes to the pre-contingency power system. Some of these can include:
1. complete bus outages;
2. electric Islanding;
3. the combined outages or re-energization of series or shunt branches, generators, loads and other facilities; and
4. change in network topology due to bus splitting.

The security itself can then be further described by preventive security and corrective security. In preventive SCOPF, power systems will suffer no constraint violation following any single or double contingency and the resulting response of automatic controls. The “preventive” SCOPF is a form of SCOPF that does not consider the possibility of corrective actions in post-contingency states, other than those that take place automatically. Therefore, in the preventive SCOPF, the values of the non-automatic control variables are the same in all system states. Methodologies disclosed herein can inherently handle this form of SCOPF. Furthermore, aspects of the invention can be expanded to include corrective actions for a given contingency. This would be referred to as “corrective” SCOPF. Those skilled in the art will readily understand how to make such expansions.

### VIII Handling Voltage and Transient Stability in SCOPF

The preventive and corrective actions or the set-points changes identified by the SCOPF must be validated using time-domain simulations in order to ensure that they will not cause any instability. An implicit assumption of the SCOPF (once it has converged) is that upon a contingency or set-point change, the system will not go unstable and will actually reach a steady-state. This assumption is validated in our invention by inducing a conservative set of inequality constraints. In addition, the proposed invention is based on equivalent circuit formulation and can, therefore, incorporate any set of algebraic equations that describe the physics of the actual device to make sure that the device does not go unstable.

### IX Example Computer System

It is to be noted that any one or more of the aspects and embodiments described herein may be conveniently implemented in and/or using one or more machines (e.g., one or more computers, one or more communications network devices, one or more electrical distribution network devices, any combination and/or network thereof, among other things) programmed according to the teachings of the present specification, as will be apparent to those of ordinary skill in the computer arts. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, a laptop computer, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

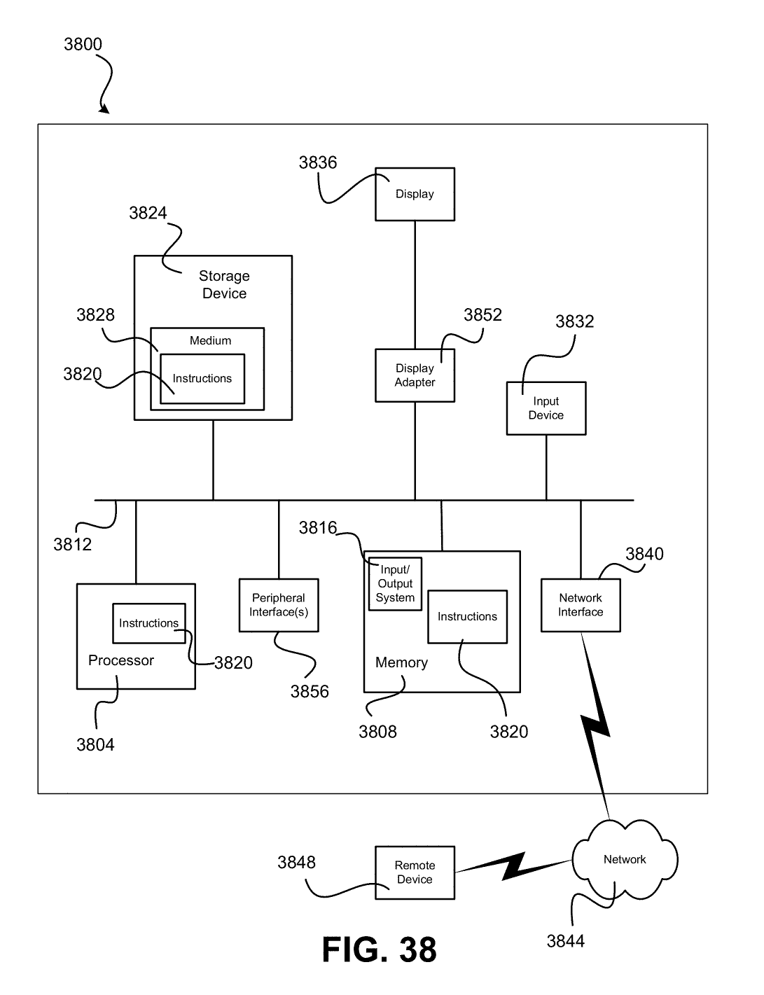

FIG. 38 shows a diagrammatic representation of one embodiment of a computing device in the exemplary form of a computer system 3800 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to contain and/or perform any one or more of the aspects and/or methodologies of the present disclosure. Computer system 3800 includes a processor 3804 and a memory 3808 that communicate with each other, and with other components, via a bus 3812. Bus 3812 may include any of several types of bus structures including, but not limited to, a memory bus, a memory controller, a peripheral bus, a local bus, and any combinations thereof, using any of a variety of bus architectures.

Memory 3808 may include various components (e.g., machine-readable media) including, but not limited to, a random access memory component, a read only component, and any combinations thereof. In one example, a basic input/output system 3816 (BIOS), including basic routines that help to transfer information between elements within computer system 3800, such as during start-up, may be stored in memory 3808. Memory 3808 may also include (e.g., stored on one or more machine-readable media) instructions (e.g., software) 3820 embodying any one or more of the aspects and/or methodologies of the present disclosure. In another example, memory 3808 may further include any number of program modules including, but not limited to, an operating system, one or more application programs, other program modules, program data, and any combinations thereof.

Computer system 3800 may also include a storage device 3824. Examples of a storage device (e.g., storage device 3824) include, but are not limited to, a hard disk drive, a magnetic disk drive, an optical disc drive in combination with an optical medium, a solid-state memory device, and any combinations thereof. Storage device 3824 may be connected to bus 3812 by an appropriate interface (not shown). Example interfaces include, but are not limited to, SCSI, advanced technology attachment (λTA), serial λTA, universal serial bus (USB), IEEE 1394 (FIREWIRE), and any combinations thereof. In one example, storage device 3824 (or one or more components thereof) may be removably interfaced with computer system 3800 (e.g., via an external port connector (not shown)). Particularly, storage device 3824 and an associated machine-readable medium 3828 may provide nonvolatile and/or volatile storage of machine-readable instructions, data structures, program modules, and/or other data for computer system 3800. In one example, software 3820 may reside, completely or partially, within machine-readable medium 3828. In another example, software 3820 may reside, completely or partially, within processor 3804.

Computer system 3800 may also include an input device 3832. In one example, a user of computer system 3800 may enter commands and/or other information into computer system 3800 via input device 3832. Examples of an input device 3832 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 3832 may be interfaced to bus 3812 via any of a variety of interfaces (not shown) including, but not limited to, a serial interface, a parallel interface, a game port, a USB interface, a FIREWIRE interface, a direct interface to bus 3812, and any combinations thereof. Input device 3832 may include a touch screen interface that may be a part of or separate from display 3836, discussed further below. Input device 3832 may be utilized as a user selection device for selecting one or more graphical representations in a graphical interface as described above.

A user may also input commands and/or other information to computer system 3800 via storage device 3824 (e.g., a removable disk drive, a flash drive, etc.) and/or network interface device 3840. A network interface device, such as network interface device 3840, may be utilized for connecting computer system 3800 to one or more of a variety of networks, such as network 3844, and one or more remote devices 3848 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 3844, may employ a wired and/or a wireless mode of communication. In general, any network topology may be used. Information (e.g., data, software 3820, etc.) may be communicated to and/or from computer system 3800 via network interface device 3840.

Computer system 3800 may further include a video display adapter 3852 for communicating a displayable image to a display device, such as display device 3836. Examples of a display device include, but are not limited to, a liquid crystal display (LCD), a cathode ray tube (CRT), a plasma display, a light emitting diode (LED) display, and any combinations thereof. Display adapter 3852 and display device 3836 may be utilized in combination with processor 3804 to provide graphical representations of aspects of the present disclosure. In addition to a display device, computer system 3800 may include one or more other peripheral output devices including, but not limited to, an audio speaker, a printer, and any combinations thereof. Such peripheral output devices may be connected to bus 3812 via a peripheral interface 3856. Examples of a peripheral interface include, but are not limited to, a serial port, a USB connection, a FIREWIRE connection, a parallel connection, and any combinations thereof.

The foregoing has been a detailed description of illustrative embodiments of the invention. It is noted that in the present specification and claims appended hereto, conjunctive language such as is used in the phrases “at least one of X, Y and Z” and “one or more of X, Y, and Z,” unless specifically stated or indicated otherwise, shall be taken to mean that each item in the conjunctive list can be present in any number exclusive of every other item in the list or in any number in combination with any or all other item(s) in the conjunctive list, each of which may also be present in any number. Applying this general rule, the conjunctive phrases in the foregoing examples in which the conjunctive list consists of X, Y, and Z shall each encompass: one or more of X; one or more of Y; one or more of Z; one or more of X and one or more of Y; one or more of Y and one or more of Z; one or more of X and one or more of Z; and one or more of X, one or more of Y and one or more of Z.

Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A method, comprising:
formulating, for an electrical power system, current and voltage conservation equations from which power flows, currents, and voltages can be derived, wherein the current and voltage conservation equations correspond to an equivalent circuit representation of the electrical power system that includes:
a real sub-circuit including all real-valued voltages and currents; and
an imaginary sub-circuit containing all imaginary-valued voltages and currents,
wherein:
the real sub-circuit and imaginary sub-circuit are coupled via controlled voltage and current sources; and
the generators are modeled by combinations of complex admittances and current or voltage sources of unknown value that represent their power delivery capabilities; and
running an optimization program for the power flow conservation equations so as to produce a minimum cost for operating the electrical power system based on the solution of control parameter values for the generator models in the system.

2. The method according to claim 1, wherein the optimization program is formulated as an equivalent circuit problem.

3. The method according to claim 2, wherein the optimization program constraints are formulated as an equivalent circuit problem.

4. The method according to claim 2, wherein the equivalent circuit problem is solved using Homotopy and/or continuation methods.

5. The method according to claim 1, wherein one or more PV generators are modeled by a conductance and a susceptance.

6. The method according to claim 1, wherein one or more load models are represented by an equivalent circuit consisting of a conductance, susceptance and current source (BIG) or circuit equivalent.

7. The method according to claim 1, wherein the nonlinear constraints are linearized such that the optimization program can be solved using sequential quadratic programming (SQP).

8. The method according to claim 1, wherein the original optimization program nonlinearities are first relaxed to obtain the lower bound on the global optimal solution, which is then used as the initial starting point for solution of the original nonlinear optimization program.

9. The method according to claim 8, wherein the process is repeated iteratively wherein the results from each iteration are used to tighten the constraints for the relaxed optimization program until the resulting lower bound on the global optimal solution is within a certain tolerance with regard to its match to the solution of the original nonlinear optimization program.

10. The method according to claim 1, wherein the equivalent circuit formulation allows the implementation of Unit commitment analysis within the optimization problem.

11. The method according to claim 1, wherein the equivalent circuit formulation allows the minimization of real power loses within the optimization problem.

12. The method according to claim 1, wherein the equivalent circuit formulation allows the minimization of reactive power loses within the optimization problem.

13. The method according to claim 1, wherein the equivalent circuit formulation allows the optimization of reactive power reserves within the formulated program.

14. The method according to claim 1, wherein the equivalent circuit formulation allows the optimization of adjustable branch impedances within the formulated program.

15. The method according to claim 1, wherein the equivalent circuit formulation allows the optimization of adjustable bus shunts within the formulated program.

16. The method according to claim 1, further including controlling the electrical power system based on the minimum cost.

17. The method according to claim 16, wherein the controlling of the electrical power system includes:
generating one or more device control signals based on the minimum cost, wherein each of the one or more device control signals are configured to respectively control one or more corresponding devices of the electrical power system that affect cost of operating the electrical power system; and
causing the one or more device control signals to be transmitted to corresponding respective one(s) of the device(s).

18. A machine-readable storage medium containing machine-executable instructions configured to cause one or more processors to perform operations comprising:
formulating, for an electrical power system, current and voltage conservation equations from which power flows, currents, and voltages can be derived, wherein the current and voltage conservation equations correspond to an equivalent circuit representation of the electrical power system that includes:
a real sub-circuit including all real-valued voltages and currents; and
an imaginary sub-circuit containing all imaginary-valued voltages and currents,
wherein:
the real sub-circuit and imaginary sub-circuit are coupled via controlled voltage and current sources; and
the generators are modeled by combinations of complex admittances and current or voltage sources of unknown value that represent their power delivery capabilities; and
running an optimization program for the power flow conservation equations so as to produce a minimum cost for operating the electrical power system based on the solution of control parameter values for the generator models in the system.

19. The machine-readable storage medium according to claim 18, wherein the optimization program is formulated as an equivalent circuit problem.

20. The machine-readable storage medium according to claim 19, wherein the optimization program constraints are formulated as an equivalent circuit problem.

21. The machine-readable storage medium according to claim 19, wherein the equivalent circuit problem is solved using Homotopy and/or continuation methods.

22. The machine-readable storage medium according to claim 18, wherein one or more PV generators are modeled by a conductance and a susceptance.

23. The machine-readable storage medium according to claim 18, wherein one or more load models are represented by an equivalent circuit consisting of a conductance, susceptance and current source (BIG) or circuit equivalent.

24. The machine-readable storage medium according to claim 18, wherein the nonlinear constraints are linearized such that the optimization program can be solved using sequential quadratic programming (SQP).

25. The machine-readable storage medium according to claim 18, wherein the original optimization program nonlinearities are first relaxed to obtain the lower bound on the global optimal solution, which is then used as the initial starting point for solution of the original nonlinear optimization program.

26. The machine-readable storage medium according to claim 25, wherein the process is repeated iteratively wherein the results from each iteration are used to tighten the constraints for the relaxed optimization program until the resulting lower bound on the global optimal solution is within a certain tolerance with regard to its match to the solution of the original nonlinear optimization program.

27. The machine-readable storage medium according to claim 18, wherein the equivalent circuit formulation allows the implementation of Unit commitment analysis within the optimization problem.

28. The machine-readable storage medium according to claim 18, wherein the equivalent circuit formulation allows the minimization of real power loses within the optimization problem.

29. The machine-readable storage medium according to claim 18, wherein the equivalent circuit formulation allows the minimization of reactive power loses within the optimization problem.

30. The machine-readable storage medium according to claim 18, wherein the equivalent circuit formulation allows the optimization of reactive power reserves within the formulated program.

31. The machine-readable storage medium according to claim 18, wherein the equivalent circuit formulation allows the optimization of adjustable branch impedances within the formulated program.

32. The machine-readable storage medium according to claim 18, wherein the equivalent circuit formulation allows the optimization of adjustable bus shunts within the formulated program.

33. The machine-readable storage medium according to claim 18, further including controlling the electrical power system based on the minimum cost.

34. The machine-readable storage medium according to claim 33, wherein the controlling of the electrical power system includes:
generating one or more device control signals based on the minimum cost, wherein each of the one or more device control signals are configured to respectively control one or more corresponding devices of the electrical power system that affect cost of operating the electrical power system; and
causing the one or more device control signals to be transmitted to corresponding respective one(s) of the device(s).
